(19) United States
(12) Patent Application Publication
(10) Pub. No.: US 2024/0155024 A1
(43) Pub. Date: May 9, 2024

(54) AUTO-DOCUMENTATION FOR APPLICATION PROGRAM INTERFACES BASED ON NETWORK REQUESTS AND RESPONSES

(71) Applicant: KONG INC., San Francisco, CA (US)

(72) Inventors: Marco Palladino, San Francisco, CA (US); Augusto Marietti, San Francisco, CA (US)

(21) Appl. No.: 18/407,244

(22) Filed: Jan. 8, 2024

Related U.S. Application Data
(63) Continuation-in-part of application No. 18/500,372, filed on Nov. 2, 2023.
Application No. 18/500,372 is a continuation of application No. 18/154,682, filed on Jan. 13, 2023, now Pat. No. 11,838,355.
Application No. 18/154,682 is a continuation of application No. 16/933,287, filed on Jul. 20, 2020, now Pat. No. 11,582,291.
Application No. 16/933,287 is a continuation-in-part of application No. 16/254,788, filed on Jan. 23, 2019, now abandoned.
Application No. 16/254,788 is a continuation of application No. 15/974,532, filed on May 8, 2018, now Pat. No. 10,225,330.
Application No. 15/974,532 is a continuation-in-part of application No. 15/899,529, filed on Feb. 20, 2018, now Pat. No. 10,097,624.
Application No. 15/899,529 is a continuation of application No. 15/662,539, filed on Jul. 28, 2017, now Pat. No. 9,936,005.
Application No. 16/933,287 is a continuation-in-part of application No. 16/714,662, filed on Dec. 13, 2019, now Pat. No. 11,171,842.
(60) Provisional application No. 62/896,412, filed on Sep. 5, 2019.

(51) Int. Cl. H04L 67/10; G06F 8/73; H04L 67/1004

(52) U.S. Cl. CPC H04L 67/10; G06F 8/73; H04L 67/1004; H04L 67/02

(57) ABSTRACT

Disclosed embodiments are directed at systems, methods, and architecture for providing auto-documentation to APIs. The auto documentation plugin is architecturally placed between an API and a client thereof and parses API requests and responses in order to generate auto-documentation. In some embodiments, the auto-documentation plugin is used to update preexisting documentation after updates. In some embodiments, the auto-documentation plugin accesses an on-line documentation repository. In some embodiments, the auto-documentation plugin makes use of a machine learning model to determine how and which portions of an existing documentation file to update.

### CROSS-REFERENCE TO RELATED APPLICATIONS

This application is a continuation-in-part of Ser. No. 18/500,372, filed Nov. 2, 2023, which is a continuation of Ser. No. 18/154,682, filed Jan. 13, 2023, now U.S. Pat. No. 11,838,355, which is a continuation of Ser. No. 16/933,287, filed Jul. 20, 2020, now U.S. Pat. No. 11,582,291, which is a continuation-in-part of U.S. patent application Ser. No. 16/254,788, filed Jan. 23, 2019, which is a continuation of U.S. patent application Ser. No. 15/974,532, filed May 8, 2018, now U.S. Pat. No. 10,225,330, issued Mar. 5, 2019, which is a continuation-in-part of U.S. patent application Ser. No. 15/999,529, filed on Feb. 20, 2018, now U.S. Pat. No. 10,097,624, issued Oct. 9, 2018 that is, in turn, a continuation application of U.S. patent application Ser. No. 15/662,539 filed on Jul. 28, 2017, now U.S. Pat. No. 9,936,005, issued Apr. 3, 2018. U.S. application Ser. No. 16/933,287, filed Jul. 20, 2020, is also a continuation-in-part of U.S. patent application Ser. No. 16/714,662, filed Dec. 13, 2019, now U.S. Pat. No. 11,171,842, which claims the benefit of priority to U.S. Provisional Application No. 62/996,412 and filed Sep. 5, 2019. The aforementioned applications are incorporated herein by reference in their entirety.

### BACKGROUND

Application programming interfaces (APIs) are specifications primarily used as an interface platform by software components to enable communication with each other. For example, APIs can include specifications for clearly defined routines, data structures, object classes, and variables. Thus, an API defines what information is available and how to send or receive that information.

Setting up multiple APIs is a time-consuming challenge. This is because deploying an API requires tuning the configuration or settings of each API individually. The functionalities of each individual API are confined to that specific API and servers hosting multiple APIs are individually set up for hosting the APIs, this makes it very difficult to build new APIs or even scale and maintain existing APIs. This becomes even more challenging when there are tens of thousands of APIs and millions of clients requesting API-related services per day. These same tens of thousands of APIs are updated regularly. Consequently, updating the associated documentation with these APIs is a tedious and cumbersome activity. Consequently, this results in reduced system productivity.

### BRIEF DESCRIPTION OF THE DRAWINGS

FIG. 1A illustrates a prior art approach with multiple APIs having functionalities common to one another.

FIG. 1B illustrates a distributed API gateway architecture, according to an embodiment of the disclosed technology.

FIG. 2 illustrates a block diagram of an example environment suitable for functionalities provided by a gateway node, according to an embodiment of the disclosed technology.

FIG. 3A illustrates a block diagram of an example environment with a cluster of gateway nodes in operation, according to an embodiment of the disclosed technology.

FIG. 3B illustrates a schematic of a data store shared by multiple gateway nodes, according to an embodiment of the disclosed technology.

FIG. 4A and FIG. 4B illustrate example ports and connections of a gateway node, according to an embodiment of the disclosed technology.

FIG. 5 illustrates a flow diagram showing steps involved in the installation of a plugin at a gateway node, according to an embodiment of the disclosed technology.

FIG. 6 illustrates a sequence diagram showing components and associated steps involved in loading configurations and code at runtime, according to an embodiment of the disclosed technology.

FIG. 7 illustrates a sequence diagram of a generative AI plugin to automatic generation of API-documentation, according to an embodiment of the disclosed technology.

FIG. 8 illustrates a sequence diagram of a use-case showing components and associated steps involved in generating auto-documentation, according to an embodiment of the disclosed technology.

FIG. 9 illustrates a flow diagram showing steps involved in generating auto-documentation, according to an embodiment of the disclosed technology.

FIG. 10 is a block diagram that illustrates connecting an index set of traffic to an AI plugin.

FIG. 11 is a block diagram of a control plane system for a service mesh in a microservices architecture.

FIG. 12 is a block diagram illustrating communication between APIs resulting in updated documentation.

FIG. 13 is a block diagram illustrating service groups and features associated with identification thereof.

FIG. 14 is a flowchart illustrating automatic generating of API tests.

FIG. 15 depicts a diagrammatic representation of a machine in the example form of a computer system within a set of instructions, causing the machine to perform any one or more of the methodologies discussed herein, to be executed.

FIG. 16 is a high-level block diagram illustrating an example AI system, in accordance with one or more embodiments.

### DETAILED DESCRIPTION

The disclosed technology describes how to automatically generate or update documentation for an API by monitoring, parsing, and sniffing requests/responses to/from the API through network nodes such as proxy servers, gateways, and control planes. In network routing and microservices applications, the control plane is the part of the router architecture that is concerned with drawing the network topology, or the routing table that defines what to do with incoming packets. Control plane logic also can define certain packets to be discarded, as well as preferential treatment of certain packets for which a high quality of service is defined by such mechanisms as differentiated services.

In monolithic application architecture, a control plane operates outside the core application. In a microservices architecture, the control plane operates between each API that makes up the microservice architecture. Proxies operate linked to each API. The proxy attached to each API is referred to as a “data plane proxy.” Examples of a data plane proxy include the sidecar proxies of Envoy proxies.

The generation or updates of documentation are implemented in a number of ways and based on a number of behavioral indicators described herein.

The following description and drawings are illustrative and are not to be construed as limiting. Numerous specific details are described to provide a thorough understanding of the disclosure. However, in certain instances, well-known or conventional details are not described in order to avoid obscuring the description. References to an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure are directed at systems, methods, and architecture for providing microservices and a plurality of APIs to requesting clients. The architecture is a distributed cluster of gateway nodes that jointly provide microservices and the plurality of APIs. Providing the APIs includes providing a plurality of plugins that implement the APIs. As a result of a distributed architecture, the task of API management can be distributed across a cluster of gateway nodes. Every request being made to an API hits a gateway node first, and then the request is proxied to the target API. The gateway nodes effectively become the entry point for every API-related request. The disclosed embodiments are well-suited for use in mission critical deployments at small and large organizations. Aspects of the disclosed technology do not impose any limitation on the type of APIs. For example, these APIs can be proprietary APIs, publicly available APIs, or invite-only APIs.

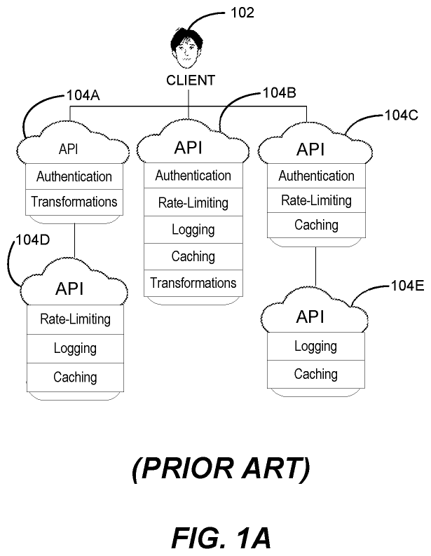

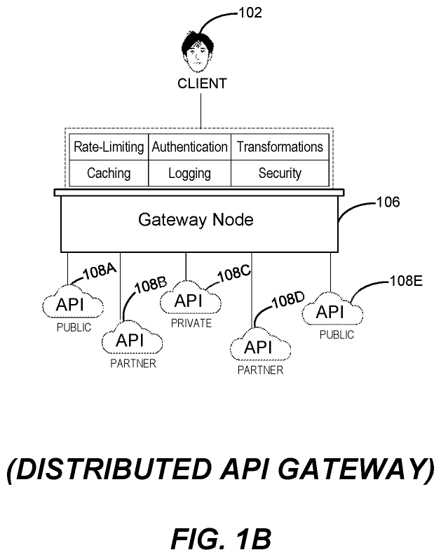

FIG. 1A illustrates a prior art approach with multiple APIs having functionalities common to one another. As shown in FIG. 1A, a client 102 is associated with APIs 104A, 104B, 104C, 104D, and 104E. Each API has a standard set of features or functionalities associated with it. For example, the standard set of functionalities associated with API 104A are “authentication” and “transformations.” The standard set of functionalities associated with API 1048 are “authentication,” “rate-limiting,” “logging,” “caching,” and “transformations.” Thus, “authentication” and “transformations” are functionalities that are common to APIs 104A and 1048. Similarly, several other APIs in FIG. 1A share common functionalities. However, it is noted that having each API handle its own functionalities individually causes duplication of efforts and code associated with these functionalities, which is inefficient. This problem becomes significantly more challenging when there are tens of thousands of APIs and millions of clients requesting API-related services per day.

FIG. 1B illustrates a distributed API gateway architecture according to an embodiment of the disclosed technology. To address the challenge described in connection with FIG. 1A, the disclosed technology provides a distributed API gateway architecture as shown in FIG. 1B. Specifically, disclosed embodiments implement common API functionalities by bundling the common API functionalities into a gateway node 106 (also referred to herein as an API Gateway). Gateway node 106 implements common functionalities as a core set of functionalities that runs in front of APIs 108A, 108B, 108C, 108D, and 108E. The core set of functionalities include rate limiting, caching, authentication, logging, transformations, and security. It will be understood that the above-mentioned core set of functionalities are for examples and illustrations. There can be other functionalities included in the core set of functionalities besides those discussed in FIG. 1 B. In some applications, gateway node 106 can help launch large-scale deployments in a very short time at reduced complexity and is therefore an inexpensive replacement for expensive proprietary API management systems. The disclosed technology includes a distributed architecture of gateway nodes with each gateway node bundled with a set of functionalities that can be extended depending on the use-case or applications.

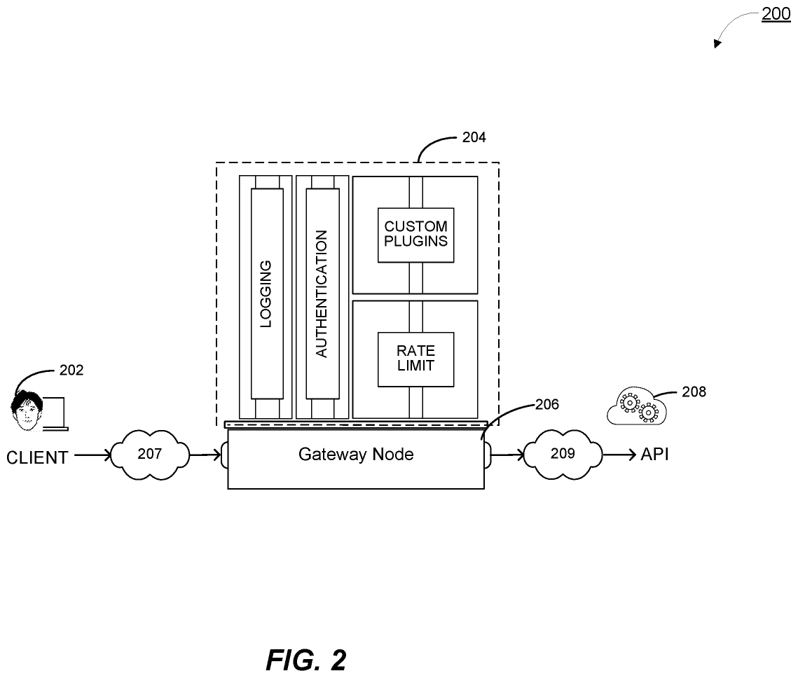

FIG. 2 illustrates a block diagram of an example environment suitable for functionalities provided by a gateway node according to an embodiment of the disclosed technology. In some embodiments, a core set of functionalities are provided in the form of “plugins” or “add-ons” installed at a gateway node. (Generally, a plugin is a component that allows modification of what a system can do usually without forcing a redesign/compile of the system. When an application supports plug-ins, it enables customization. The common examples are the plug-ins used in web browsers to add new features such as search-engines, virus scanners, or the ability to utilize a new file type such as a new video format.)

As an example, a set of plugins 204 shown in FIG. 2 are provided by gateway node 206 positioned between a client 202 and one or more HTTP APIs. Electronic devices operated by client 202 can include, but are not limited to, a server desktop, a desktop computer, a computer cluster, a mobile computing device such as a notebook, a laptop computer, a handheld computer, a mobile phone, a smart phone, a PDA, a BlackBerry™ device, a Treo™, and/or an iPhone or Droid device, etc. Gateway node 206 and client 202 are configured to communicate with each other via network 207. Gateway node 206 and one or more APIs 208 are configured to communicate with each other via network 209. In some embodiments, the one or more APIs reside in one or more API servers, API data stores, or one or more API hubs. Various combinations of configurations are possible.

Networks 207 and 209 can be any collection of distinct networks operating wholly or partially in conjunction to provide connectivity to/from client 202 and one or more APIs 208. In one embodiment, network communications can be achieved by, an open network, such as the Internet, or a private network, such as an intranet and/or the extranet. Networks 207 and 209 can be a telephonic network, an open network, such as the Internet, or a private network, such as an intranet and/or the extranet. For example, the Internet can provide file transfer, remote login, email, news, RSS, and other services through any known or convenient protocol, such as, but not limited to the TCP/IP protocol, Open System Interconnections (OSI), FTP, UPnP, iSCSI, NSF, ISDN, PDH, RS-232, SDH, SONET, etc.

Client 202 and one or more APIs 208 can be coupled to the network 150 (e.g., Internet) via a dial-up connection, a digital subscriber loop (DSL, ADSL), cable modem, wireless connections, and/or other types of connection. Thus, the client devices 102A-N, 112A-N, and 122A-N can communicate with remote servers (e.g., API servers 130A-N, hub servers, mail servers, instant messaging servers, etc.) that provide access to user interfaces of the World Wide Web via a web browser, for example.

The set of plugins 204 include authentication, logging, rate-limiting, and custom plugins, of which authentication, logging, traffic control, rate-limiting can be considered as the core set of functionalities. An authentication functionality can allow an authentication plugin to check for valid login credentials such as usernames and passwords. A logging functionality of a logging plugin logs data associated with requests and responses. A traffic control functionality of a traffic control plugin manages, throttles, and restricts inbound and outbound API traffic. A rate limiting functionality can allow managing, throttling, and restricting inbound and outbound API traffic. For example, a rate limiting plugin can determine how many HTTP requests a developer can make in a given period of seconds, minutes, hours, days, months or years.

A plugin can be regarded as a piece of stand-alone code. After a plugin is installed at a gateway node, it is available to be used. For example, gateway node 206 can execute a plugin in between an API-related request and providing an associated response to the API-related request. One advantage of the disclosed system is that the system can be expanded by adding new plugins. In some embodiments, gateway node 206 can expand the core set of functionalities by providing custom plugins. Custom plugins can be provided by the entity that operates the cluster of gateway nodes. In some instances, custom plugins are developed (e.g., built from “scratch”) by developers or any user of the disclosed system. It can be appreciated that plugins, used in accordance with the disclosed technology, facilitate in centralizing one or more common functionalities that would be otherwise distributed across the APIs, making it harder to build, scale and maintain the APIs.

Other examples of plugins can be a security plugin, a monitoring and analytics plugin, and a transformation plugin. A security functionality can be associated with the system restricting access to an API by whitelisting or blacklisting/whitelisting one or more consumers identified, for example, in one or more Access Control Lists (ACLs). In some embodiments, the security plugin requires an authentication plugin to be enabled on an API. In some use cases, a request sent by a client can be transformed or altered before being sent to an API. A transformation plugin can apply a transformations functionality to alter the request sent by a client. In many use cases, a client might wish to monitor request and response data. A monitoring and analytics plugin can allow monitoring, visualizing, and inspecting APIs and microservices traffic.

In some embodiments, a plugin is Lua code that is executed during the life-cycle of a proxied request and response. Through plugins, functionalities of a gateway node can be extended to fit any custom need or integration challenge. For example, if a consumer of the disclosed system needs to integrate their API's user authentication with a third-party enterprise security system, it can be implemented in the form of a dedicated (custom) plugin that is run on every request targeting that given API. One advantage, among others, of the disclosed system is that the distributed cluster of gateway nodes is scalable by simply adding more nodes, implying that the system can handle virtually any load while keeping latency low.

One advantage of the disclosed system is that it is platform agnostic, which implies that the system can run anywhere. In one implementation, the distributed cluster can be deployed in multiple data centers of an organization. In some implementations, the distributed cluster can be deployed as multiple nodes in a cloud environment. In some implementations, the distributed cluster can be deployed as a hybrid setup involving physical and cloud computers. In some other implementations, the distributed cluster can be deployed as containers.

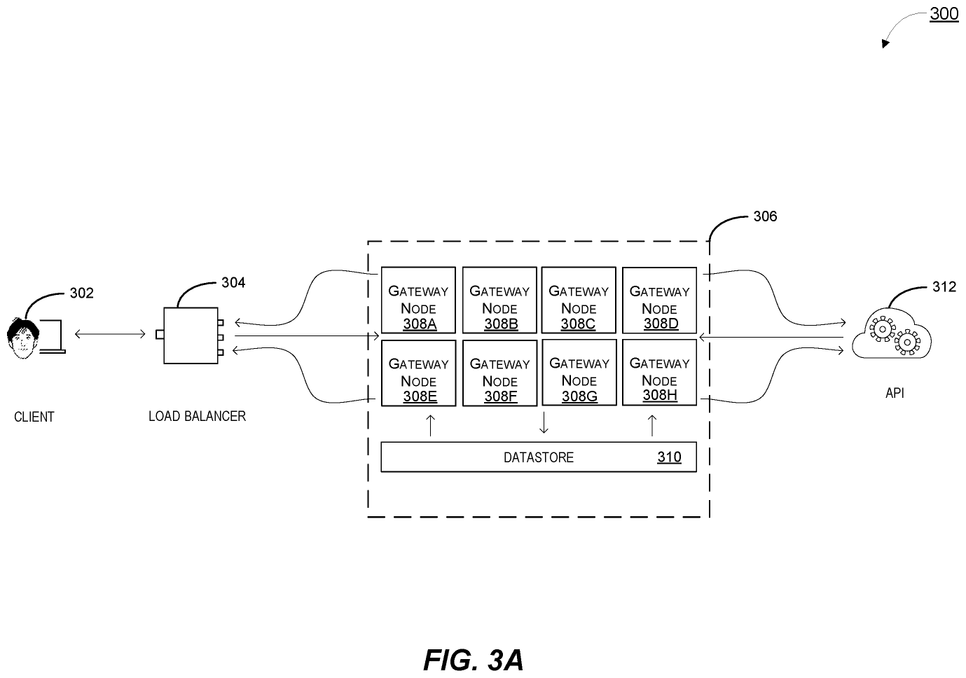

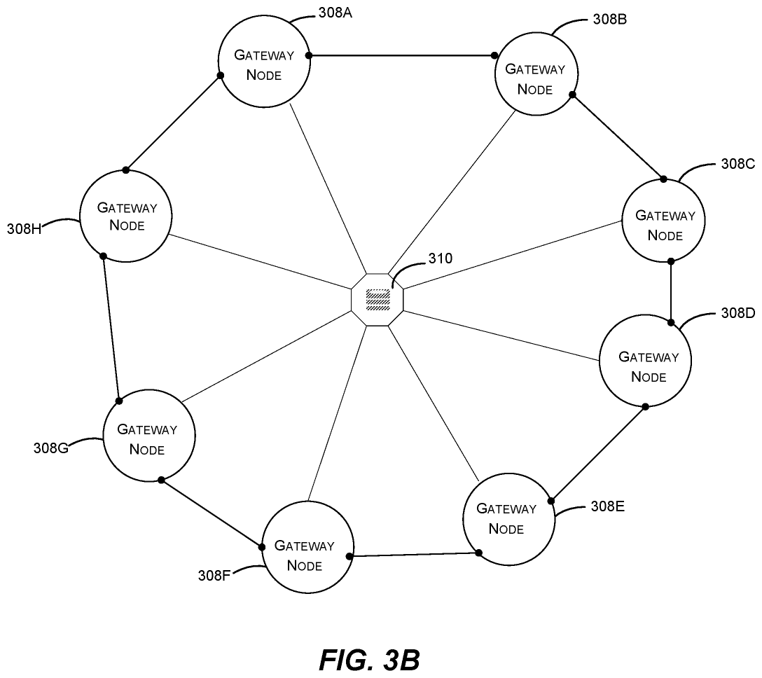

FIG. 3A illustrates a block diagram of an example environment with a cluster of gateway nodes in operation. In some embodiments, a gateway node is built on top of NGINX. NGINX is a high-performance, highly-scalable, highly-available web server, reverse proxy server, and web accelerator (combining the features of an HTTP load balancer, content cache, and other features). In an example deployment, a client 302 communicates with one or more APIs 312 via load balancer 304, and a cluster of gateway nodes 306. The cluster of gateway nodes 306 can be a distributed cluster. The cluster of gateway nodes 306 includes gateway nodes 308A—308H and data store 310. The functions represented by the gateway nodes 308A—308H and/or the data store 310 can be implemented individually or in any combination thereof, partially or wholly, in hardware, software, or a combination of hardware and software.

Load balancer 304 provides functionalities for load balancing requests to multiple backend services. In some embodiments, load balancer 304 can be an external load balancer. In some embodiments, the load balancer 304 can be a DNS-based load balancer. In some embodiments, the load balancer 304 can be a Kubernetes® load balancer integrated within the cluster of gateway nodes 306.

Data store 310 stores all the data, routing information, plugin configurations, etc. Examples of a data store can be Apache Cassandra or PostgreSQL. In accordance with disclosed embodiments, multiple gateway nodes in the cluster share the same data store, e.g., as shown in FIG. 3A. Because multiple gateway nodes in the cluster share the same data store, there is no requirement to associate a specific gateway node with the data store—data from each gateway node 308A—308H is stored in data store 310 and retrieved by the other nodes (e.g., even in complex multiple data center setups). In some embodiments, the data store shares configurations and software codes associated with a plugin that is installed at a gateway node. In some embodiments, the plugin configuration and code can be loaded at runtime.

FIG. 3B illustrates a schematic of a data store shared by multiple gateway nodes, according to an embodiment of the disclosed technology. For example, FIG. 3B shows data store 310 shared by gateway nodes 308A—308H arranged as part of a cluster.

One advantage of the disclosed architecture is that the cluster of gateway nodes allow the system to be scaled horizontally by adding more gateway nodes to encompass a bigger load of incoming API-related requests. Each of the gateway nodes share the same data since they point to the same data store. The cluster of gateway nodes can be created in one datacenter, or in multiple datacenters distributed across different geographical locations, in both cloud or on-premise environments. In some embodiments, gateway nodes (e.g., arranged according to a flat network topology) between the datacenters communicate over a Virtual Private Network (VPN) connection. The system can automatically handle a new gateway node joining a cluster or leaving a cluster. Once a gateway node communicates with another gateway node, it will automatically discover all the other gateway nodes due to an underlying gossip protocol.

In some embodiments, each gateway includes an administration API (e.g., internal RESTful API) for administration purposes. Requests to the administration API can be sent to any node in the cluster. The administration API can be a generic HTTP API. Upon set up, each gateway node is associated with a consumer port and an admin port that manages the API-related requests coming into the consumer port. For example, port number 8001 is the default port on which the administration API listens and 8444 is the default port for HTTPS (e.g., admin_listen_ssl) traffic to the administration API.

In some instances, the administration API can be used to provision plugins. After a plugin is installed at a gateway node, it is available to be used, e.g., by the administration API or a declarative configuration.

In some embodiments, the administration API identifies a status of a cluster based on a health state of each gateway node. For example, a gateway node can be in one of the following states:
active: the node is active and part of the cluster.
failed: the node is not reachable by the cluster.
leaving: a node is in the process of leaving the cluster.
left: the node has left the cluster.

In some embodiments, the administration API is an HTTP API available on each gateway node that allows the user to create, restore, update, and delete (CRUD) operations on items (e.g., plugins) stored in the data store. For example, the Admin API can provision APIs on a gateway node, provision plugin configuration, create consumers, and provision their credentials. In some embodiments, the administration API can also read, update, or delete the data. Generally, the administration API can configure a gateway node and the data associated with the gateway node in the data store.

In some applications, it is possible that the data store only stores the configuration of a plugin and not the software code of the plugin. That is, for installing a plugin at a gateway node, the software code of the plugin is stored on that gateway node. This can result in efficiencies because the user needs to update his or her deployment scripts to include the new instructions that would install the plugin at every gateway node. The disclosed technology addresses this issue by storing both the plugin and the configuration of the plugin. By leveraging the administration API, each gateway node can not only configure the plugins, but also install them. Thus, one advantage of the disclosed system is that a user does not have to install plugins at every gateway node. But rather, the administration API associated with one of the gateway nodes automates the task of installing the plugins at gateway nodes by installing the plugin in the shared data store, such that every gateway node can retrieve the plugin code and execute the code for installing the plugins. Because the plugin code is also saved in the shared data store, the code is effectively shared across the gateway nodes by leveraging the data store, and does not have to be individually installed on every gateway node.

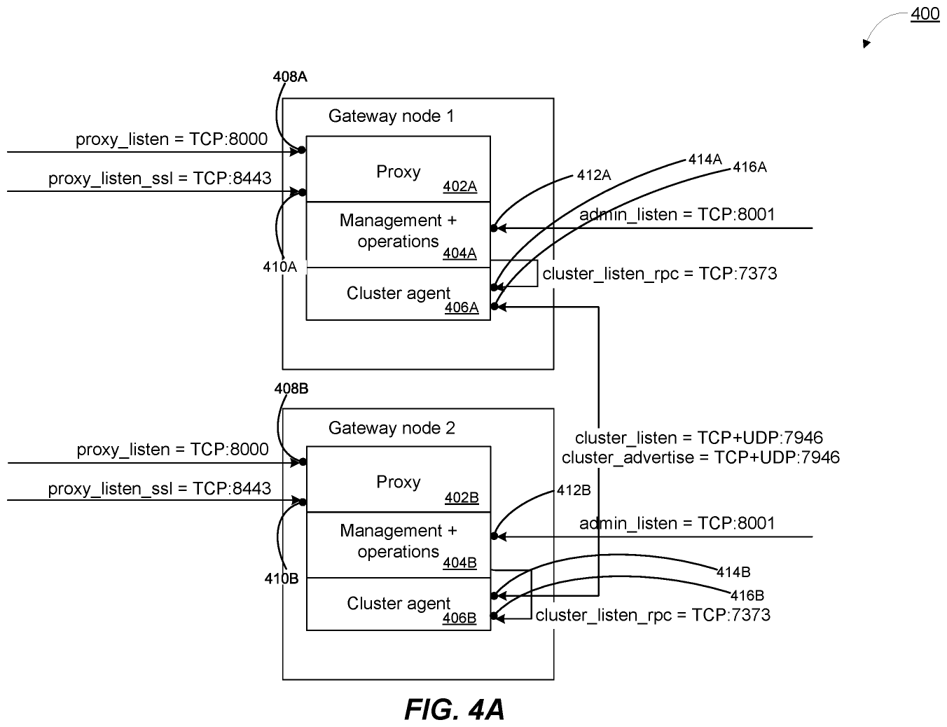

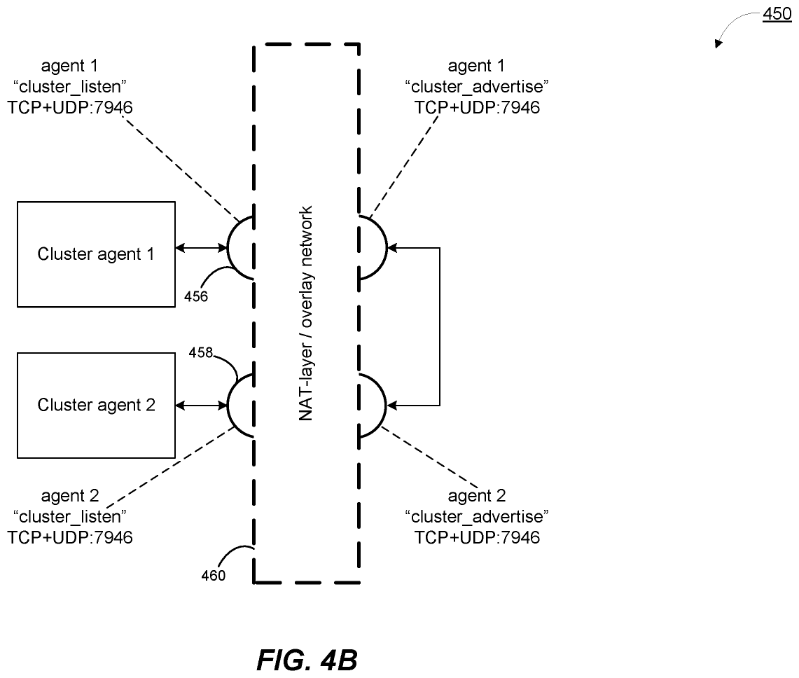

FIG. 4A and FIG. 4B illustrate example block diagrams 400 and 450 showing ports and connections of a gateway node, according to an embodiment of the disclosed technology. Specifically, FIG. 4A shows a gateway node 1 and gateway node 2. Gateway node 1 includes a proxy module 402A, a management and operations module 404A, and a cluster agent module 406A. Gateway node 2 includes a proxy module 402B, a management and operations module 404B, and a cluster agent module 406B. Gateway node 1 receive incoming traffic at ports denoted as 408A and 410A. Ports 408A and 410A are coupled to proxy module 402B. Gateway node 1 listens for HTTP traffic at port 408A. The default port number for port 408A is 8000. API-related requests are typically received at port 408A. Port 410A is used for proxying HTTPS traffic. The default port number for port 410A is 8443. Gateway node 1 exposes its administration API (alternatively, referred to as management API) at port 412A that is coupled to management and operations module 404A. The default port number for port 412A is 8001. The administration API allows configuration and management of a gateway node, and is typically kept private and secured. Gateway node 1 allows communication within itself (i.e., intra-node communication) via port 414A that is coupled to clustering agent module 406A. The default port number for port 414A is 7373. Because the traffic (e.g., TCP traffic) here is local to a gateway node, this traffic does not need to be exposed. Cluster agent module 406B of gateway node 1 enables communication between gateway node 1 and other gateway nodes in the cluster. For example, ports 416A and 416B coupled with cluster agent module 406A at gateway node 1 and cluster agent module 406B at gateway node 2 allow intra-cluster or inter-node communication. Intra-cluster communication can involve UDP and TCP traffic. Both ports 416A and 416B have the default port number set to 7946. In some embodiments, a gateway node automatically (e.g., without human intervention) detects its ports and addresses. In some embodiments, the ports and addresses are advertised (e.g., by setting the cluster_advertise property/setting to a port number) to other gateway nodes. It will be understood that the connections and ports (denoted with the numeral “B”) of gateway node 2 are similar to those in gateway node 1, and hence is not discussed herein.

FIG. 4B shows cluster agent 1 coupled to port 456 and cluster agent 2 coupled to port 458. Cluster agent 1 and cluster agent 2 are associated with gateway node 1 and gateway node 2 respectively. Ports 456 and 458 are communicatively connected to one another via a NAT-layer 460. In accordance with disclosed embodiments, gateway nodes are communicatively connected to one another via a NAT-layer. In some embodiments, there is no separate cluster agent but the functionalities of the cluster agent are integrated into the gateway nodes. In some embodiments, gateway nodes communicate with each other using the explicit IP address of the nodes.

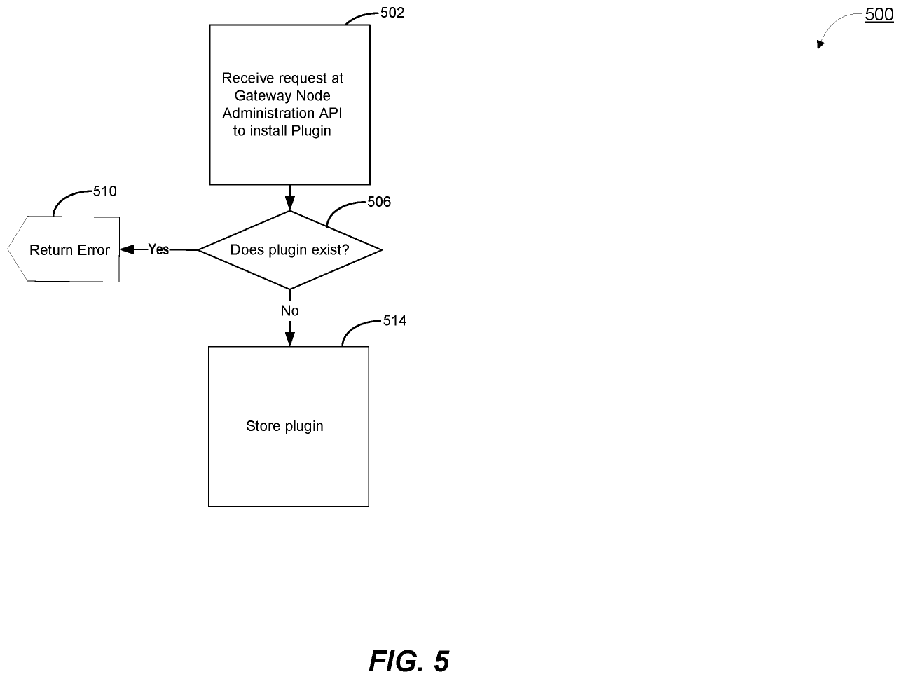

FIG. 5 illustrates a flow diagram showing steps of a process 500 involved in installation of a plugin at a gateway node, according to an embodiment of the disclosed technology. At step 502, the administration API of a gateway node receives a request to install a plugin. An example of a request is provided below:
For example:
POST/plugins/install
name=OPTIONAL_VALUE
code=VALUE
archive=VALUE

The administration API of the gateway node determines (at step 506) if the plugin exists in the data store. If the gateway node determines that the plugin exists in the data store, then the process returns (step 510) an error. If the gateway node determines that the plugin does not exist in the data store, then the process stores the plugin. (In some embodiments, the plugin can be stored in an external data store coupled to the gateway node, a local cache of the gateway node, or a third party storage. For example, if the plugin is stored at some other location besides the data store, then different policies can be implemented for accessing the plugin.) Because the plugin is now stored in the database, it is ready to be used by any gateway node in the cluster.

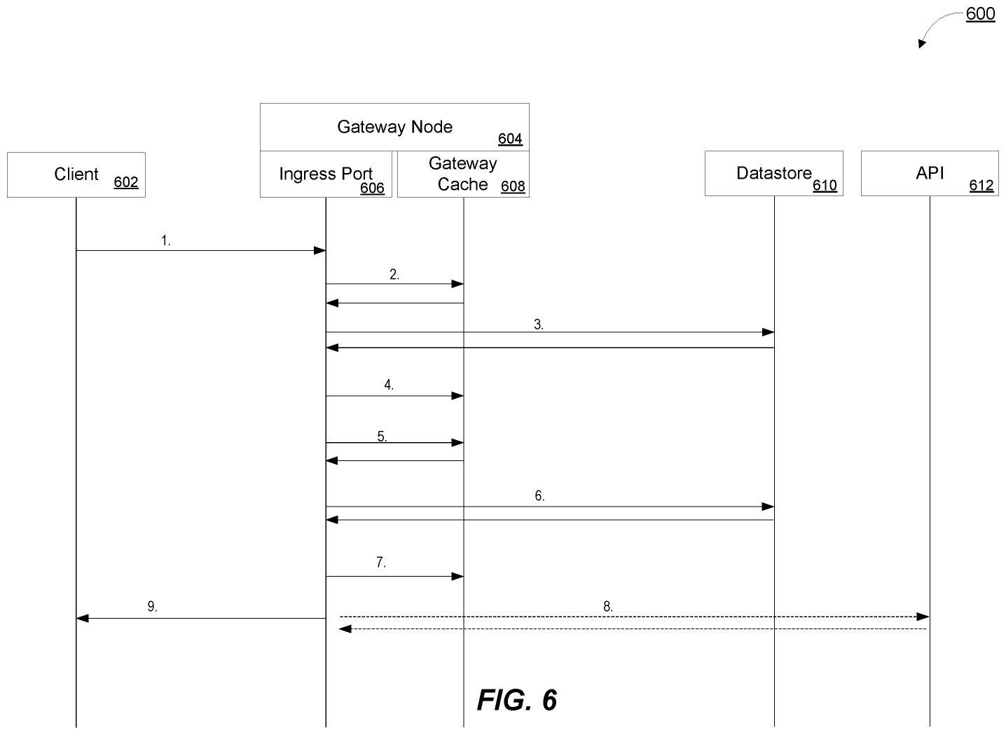

When a new API request goes through a gateway node (in the form of network packets), the gateway node determines (among other things) which plugins are to be loaded. Therefore, a gateway node sends a request to the data store to retrieve the plugin(s) that has/have been configured on the API and that need(s) to be executed. The gateway node communicates with the data store using the appropriate database driver (e.g., Cassandra or PostgresSQL) over a TCP communication. In some embodiments, the gateway node retrieves both the plugin code to execute and the plugin configuration to apply for the API, and then execute them at runtime on the gateway node (e.g., as explained in FIG. 6).

FIG. 6 illustrates a sequence diagram 600 showing components and associated steps involved in loading configurations and code at runtime, according to an embodiment of the disclosed technology. The components involved in the interaction are client 602, gateway node 604 (including an ingress port 606 and a gateway cache 608), data store 610, and an API 612. At step 1, a client makes a request to gateway node 604. At step 2, ingress port 606 of gateway node 604 checks with gateway cache 608 to determine if the plugin information and the information to process the request has already been cached previously in gateway cache 608. If the plugin information and the information to process the request is cached in gateway cache 608, then the gateway cache 608 provides such information to the ingress port 606. If, however, the gateway cache 608 informs the ingress port 606 that the plugin information and the information to process the request is not cached in gateway cache 608, then the ingress port 606 loads (at step 3) the plugin information and the information to process the request from data store 610. In some embodiments, ingress port 606 caches (for subsequent requests) the plugin information and the information to process the request (retrieved from data store 610) at gateway cache 608. At step 5, ingress port 606 of gateway node 604 executes the plugin and retrieves the plugin code from the cache, for each plugin configuration. However, if the plugin code is not cached at the gateway cache 608, the gateway node 604 retrieves (at step 6) the plugin code from data store 610 and caches (step 7) it at gateway cache 608. The gateway node 604 executes the plugins for the request and the response (e.g., by proxy the request to API 612 at step 7), and at step 8, the gateway node 604 returns a final response to the client.

### Auto-Documentation Embodiment

When releasing an API, documentation is a requisite in order for developers to learn how to consume the API. Documentation for an API is an informative text document that describes what functionality the API provides, the parameters it takes as input, what is the output of the API, how does the API operate, and other such information. Usually documenting APIs can be a tedious and extensive task. In conventional systems, developers create an API and draft the documentation for the API. This approach to drafting a documentation for the API is human-driven. That is, the documentation is changed only when human developers make changes to the documentation.

Any time the API is updated, the documentation needs to be revised. In many instances, because of pressures in meeting deadlines, developers are not able to edit the documentation at the same pace as the changes to the API. This results in the documentation not being updated which leads to frustrations because of an API having unsupported/incorrect documentation. In some unwanted scenarios, the documentation does not match the implementation of the API. The issue of documentation is exacerbated in a microservices application that includes a large number of APIs that are independently updated and developed.

The generic concept of procedurally documentation generated from source code emerged recently, though has some inherent issues that are solved herein. Procedurally generated documentation often is limited to activation by the programmer who generates the source code or updates thereto. Techniques taught herein enable the auto-documentation of code that a user does not necessarily have access to. Further, the auto-documentation is performed passively by a network node and does not burden the machine that is executing the API code; thus, a processing advantage is achieved.

In some embodiments, the disclosed system includes a specialized plugin that automatically generates documentation for an API endpoint (e.g., input and output parameters of the API endpoint) without human intervention. By parsing the stream of requests and the responses passing through a gateway node, the plugin generates the documentation automatically. In some embodiments, the auto-documentation plugin is linked to an online repository of documentation, such as GitHub, and documentation files stored thereon are updated directly using provided login credentials where necessary. As an example, if a client sends a request to/hello, and the API associated with/hello responds back with code successfully, then the plugin determines that/hello is an endpoint based on the behavioral indicator of the manner of the response. Further behavioral indicators are discussed below. In some embodiments, an API and a client may have a certain order or series of requests and responses. The API or client will first request one set of parameters, and then based on the response, another request is sent based on the values of those parameters.

In some embodiments, the plugin can parse the parameters involved in a request/response and identify those parameters in the generated auto-documentation. In some embodiments, the plugin can generate a response to a client's request. In some embodiments, the API itself can provide additional response headers (e.g., specifying additional about the fields, parameters, and endpoints) to generate a more comprehensive auto-documentation. For example, a client makes a request to/hello with the parameters name, age, and id. The parameters are titled such that a semantic analysis of the collection of parameter titles are identifying a person.

In some embodiments the auto-documentation plugin employs a machine learning model/artificial intelligence to create the documentation. In one example, the AI predicts what a field in the response means or that a sequence of request/responses has changed. By generating auto-documentation for one or more APIs, the auto-documentation plugin can learn to deal with fields and data that are not necessarily intuitive and compare to historical models. The plugin therefore builds a machine learning or neural net model that is leveraged to be more accurate over time, and document more accurately. The machine learning model could be hosted locally within a gateway node, or can be sent to a remote (e.g., physical or cloud) server for further refinements.

In some embodiments, the AI generates automatic documentation from an OpenAPI specification, a collection of test results that the user creates in the API gateway, Service Catalog, or in an API development platform (e.g., at the time of writing, Insomnia is a suitable development platform), or from live traffic through the API gateway, ingress controller or service mesh.

An OpenAPI specification is documentation that describes how one interacts with a given API and what to expect the general functions, calls, and responses the API will perform. The OpenAPI specification is typically less detailed than source code documentation in that an Open API specification is typically a set of definitions or a description of the functional interface as opposed to a technical description of the API source in detail.

In action, the API management platform, ingress controller, service mesh or the developer application engages with an AI such as a generative AI to automatically generate and keep up to date API documentation. The gateway can also contribute—in real-time based on traffic—to collect information that can be used to update the API/microservices documentation with the most accurate documentation. The AI-generated documentation will both generate documentation for APIs and microservices, and also for each individual route (or endpoint) for each one of them.

The generative AI is triggered by predetermined actions performed within the API management platform or the developer application. Example actions include user request, session completion (e.g., a developer user closes a file they are working on), running a functionality/runtime test, the user causes an active file to be saved, a lull or a pause in changes of a predetermined time period, or a changelog determines that a threshold change has been made to a subject file.

Examples of a threshold change include inclusion or deletion of a predetermined list of characters that have a significant impact on execution of code, changing of naming conventions of particular objects, or changing a predetermined number of characters.

Execution of the AI auto-documentation plugin is performed in “the background” and does not impact the developer experience while they work. That is, the generative AI call is performed in parallel while the developer user is doing making changes or performing a runtime test that includes other interactive developer tasks/action items. Thus, the AI call does not increase the latency of the API management platform or developer application. In some embodiments, the AI plugin is an API that executes on a cloud server (thereby employing remote processing power) and communicates the management platform or developer application via a microservice architecture.

The specific AI call or query is based on the change or new API information available. For example, where an OpenAPI specification is available the AI is queried to find the recited definitions in the source code and interpret the corresponding code and explain what the code does. The recited definitions are thus employed as the AI calls or triggers. In another example, an existing documentation file is modified based on a source code change. In such circumstances, the AI is triggered to interpret existing documentation text and identify how the source code change modifies that existing documentation and make the explanatory text change.

According to the disclosed auto-documentation plugin, the API provides an endpoint for the plugin to consume so that the auto-documentation plugin can obtain specific information about fields that are not obvious. For example, a “name of an entity” field that is associated with the API may be obvious, but some other fields may not be obvious. Hypothetically, a response includes an “abcd_id” field whose meaning may not be automatically inferred by a gateway node or control plane/data plane proxy, or which might be of interest for documentation purposes. In some embodiments, the auto-documentation generated can be specifically associated with the “abcd_id” field. The “abcd_id” field-specific documentation can be created when the user configures the auto-documentation plugin the first time. In some embodiments, the generated auto-documentation can be retrieved by a third-party source (e.g., another API). In some embodiments, the generated auto-documentation can be retrieved by a custom response header that the API endpoint returns to a gateway node or control plane/data plane proxy.

The purpose of the “abcd_id” field can be inferred based on both a history of response values to the parameter, and a history of many APIs that use a similarly named parameter. For example, if responses consistently include values such as “Main St.”, “74th Ln.”, “Page Mill Rd.”, and “Crossview Ct.”, it can be inferred that “abcd_id” is being used to pass names of streets to and from the related API. This history may be observed across multiple APIs. For example, while “abcd_id” may not be intuitively determined, a given programmer or team of programmers may always use the parameters named as such for particular input types (such as street names). Thus, the auto-documentation plugin can update documentation for an API receiving a new (or updated) parameter based on what that parameter means to other APIs.

Where the response values to the request change to “John Smith”, “Jane Doe”, and “Barack Obama”, then the model infers that the use of “abcd_id” has changed from names of streets to names of people. The auto-documentation plugin locates the portion of the documentation that refers to the parameter and updates the description of the use of the parameter.

Where an API and a client may have a certain order or series of requests and responses. A machine learning/AI model is employed based on the order of requests/responses using the values provided for the parameters to develop the model. For example, a historical model of a request/response schema shows 3 types of requests. First, a request with a string parameter “petType”. In responses to the first request, if the value is responded as “dog”, the subsequent request asks for the string parameter “favToy”. If the response to the first request is “cat”, the subsequent request asks for a Boolean parameter “isViolent” instead.

If a newly observed series of requests/responses instead subsequently requests for the string parameter “favToy” after the response to the first request is “cat”, then the auto-documentation plugin determines that a method that evaluates the first request has changed and that the related documentation needs to be updated.

The auto-generated documentation is in a human-readable format so that developers can understand and consume the API. When the API undergoes changes or when the request/response (e.g., parameters included in the request/response) to the API undergoes changes, the system not only auto-generates documentation but also detects changes to the request/response. Detecting the changes enables the plugin to be able to alert/notify developers when API-related attributes change (e.g., in an event when the API is updated so that a field is removed from the API's response or a new field is added in the API's response) and send the updated auto-documentation. Thus, the documentation continually evolves over time.

In some embodiments, auto-documentation for an API is generated dynamically in real-time by monitoring/sniffing/parsing traffic related to requests (e.g., sent by one or more clients) and requests (e.g., received from the API). In some embodiments, the client can be a testing client. The client might have a test suite that the client intends to execute. If the client executes the test suite through a gateway node that runs the auto-documentation plugin, then the plugin can automatically generate the documentation for the test suite.

In some embodiments, the auto-documentation plugin further makes suggestions about improvements to the API based on the OpenAPI specification of the API and based on real-time analysis of real traffic on an API. In such embodiments, the auto-documentation plugin leverages the generative AI to suggest to the developers improvements on the API that will make it better, easier to use or more capable.

The auto-documentation plugin need not review the source code of the implementation of the API, but rather reviews the interface described either via a specification format like OpenAPI spec, or via live API traffic flowing in the gateway, service mesh or ingress controller. Suggestions to improve the API revolve around: better endpoints, better parameters, better responses, better interface in general. Based on the OpenAPI specification, better security, better API/microservices policies for access control and governance, better compression algorithms, and so on.

The suggestions occur in graphic interface notifications, comments on the API specification, and/or live suggested text the follows a cursor parsing through the API specification. For example, a developer positions a cursor on a given parameter, and a suggestion window opens that suggest modifying that parameter. Suggestions influenced by the AI via live traffic are based on data such as parameter names that are synonyms or otherwise semantically similar.

For example, the AI has observed via indexed microservice traffic that a parameter entitled “location” carries a set of coordinates as its value. Thus, in an API specification, for the parameter “GPS_coords” the auto-documentation module suggests modifying the parameter to “location” to bring the subject parameter in line with the previously observed parameter.

The auto-documentation output, for example, can be a Swagger file, or OpenAPI specification that includes each endpoint, each parameter, each method/class and other API-related attributes. (A Swagger file is typically in JSON.) Thus, the auto-documentation can be in other suitable formats, e.g., RAML and API Blueprint. In some embodiments, the auto-documentation functionality is implemented as a plugin (that runs as middleware) at a gateway node.

In a microservices architecture, each microservice typically exposes a set of what are typically fine-grained endpoints, as opposed to a monolithic application where there is just one set of (typically replicated, load-balanced) endpoints. An endpoint can be considered to be a URL pattern used to communicate with an API.

In some instances, the auto-documentation can be stored or appended to an existing documentation, in-memory, on disk, in a data store or into a third-party service. In some instances, the auto-documentation can be analyzed and compared with previous versions of the same documentation to generate DIFF (i.e., difference) reports, notifications and monitoring alerts if something has changed or something unexpected has been documented.

In some embodiments, the plugin for automatically generating the documentation can artificially provoke or induce traffic (e.g., in the form of requests and responses) directed at an API so that the plugin can learn how to generate the auto-documentation for that API.

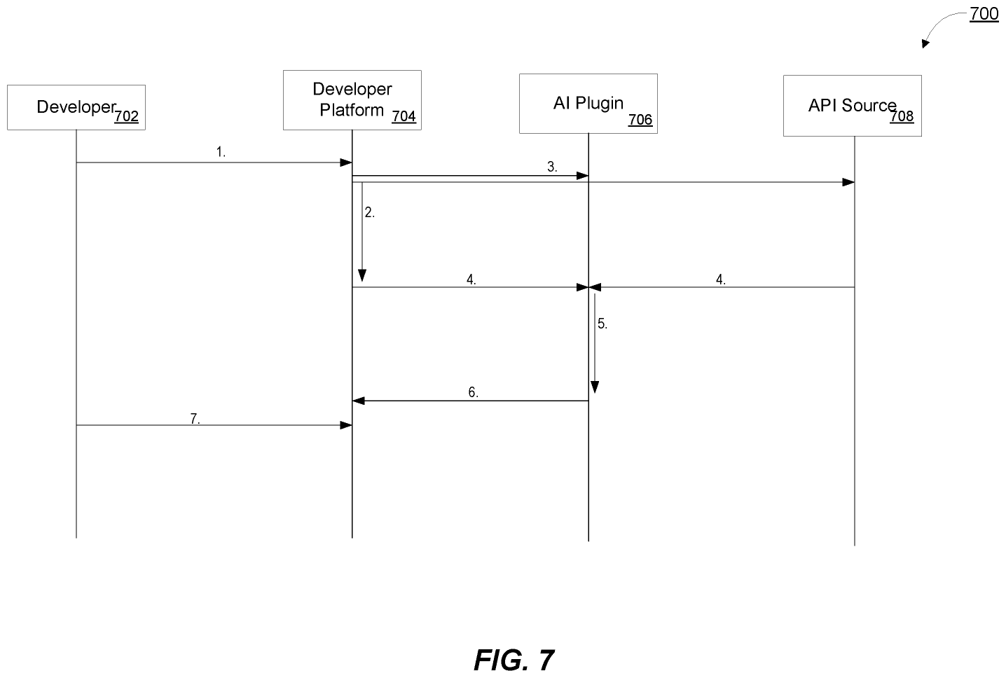

FIG. 7 illustrates a sequence diagram 700 of a generative AI plugin to automatic generation of API-documentation, according to an embodiment of the disclosed technology. Specifically, FIG. 7 corresponds to the use-case when the auto-documentation is generated based on developer activity. The components involved in the interaction are a developer 702, a developer platform 704 (e.g., an API management platform or a developer application), an AI plugin 706, and API source 708. At step 1, the developer 702 interacts with the developer platform 704. The interaction includes any of a number of potential actions. These actions include user request, importing a new API on to the developer platform 704, session completion (e.g., a developer user closes a file they are working on), running a functionality/runtime test, the user causes an active file to be saved, a lull or a pause in changes of a predetermined time period, or a changelog determines that a threshold change has been made to a subject file.

At step 2, the developer platform 704 acts on or responds to the developer action from step 1. The developer platform 704 response depends on the action. The response includes processing requests, saving data, executing tests, observing user activity, etc. In parallel with step 2, at step 3, the developer platform 704 makes an auto-documentation call to an AI plugin 706. Additionally in some embodiments of step 3, the developer platform 704 obtains API information from the API source 708. In this disclosure the API source 708 includes any of the API specification (e.g., such as an OpenAPI specification), an API Service Hub/library entry, or the source code. Some triggering activity from step 1 does not relate to the API source 708, and in those embodiments, there is no need to get data from the API source 708.

At step 4, the developer platform 704 and/or the API source 708 provides API information to the AI plugin 706 as is connected to generating a suitable query for the AI plugin relating to auto-documentation. Examples of provided information are provided elsewhere in this specification. In step 5, the AI plugin executes on the AI content generation query based on the provided information. The AI-generated documentation generates either or both of documentation for APIs and microservices, and also for each individual route (or endpoint) for each one of the APIs. In step 6, the AI plugin 706 delivers output of the AI, the documentation, to the developer platform 704. In step 7, the developer 702 accesses the documentation via the developer platform 704.

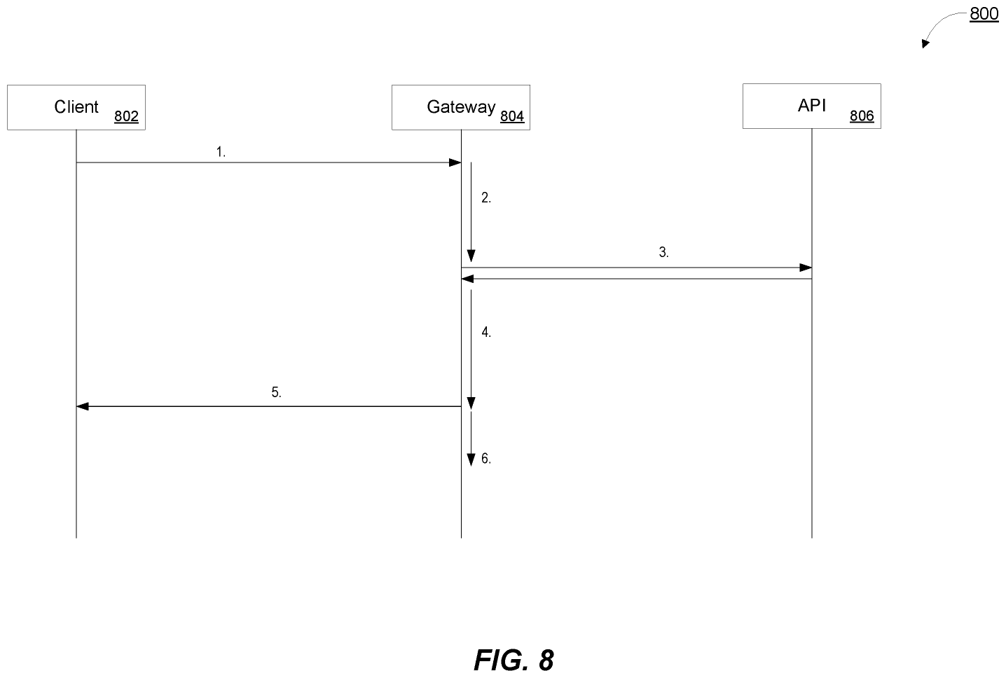

FIG. 8 illustrates a sequence diagram 800 of a use-case showing components and associated steps involved in generating auto-documentation, according to an embodiment of the disclosed technology. In some embodiments, the flow diagram corresponds to the use-case when the auto-documentation is generated based on pre-processing a request (e.g., sent by one or more clients) and post-processing a response (e.g., received from the API). The components involved in the interaction are a client 802, a control plane 804, and an API 806. At step 1, a client 802 makes a request to gateway node 804. At step 2, the gateway node 804 parses the request (e.g., the headers and body of the request) and generates auto-documentation associated with the request. (The request can be considered as one part of a complete request/response transaction.)

At step 3, the gateway node 804 proxies/load-balances the request to API 806, which returns a response. At step 4, the gateway node 804 parses the response (e.g., the headers and body of the response) returned by the API 806, and generates auto-documentation associated with the response. In some embodiments, the auto-documentation associated with the response is appended to the auto-documentation associated with the request. In some embodiments, the documentation is generated by an AI plugin managed by the gateway node 804. At step 5, the gateway node 804 proxies the response back to the client 802. At step 6, the resulting documentation is stored on-disk, in a data store coupled with the gateway node 804, submitted to a third-party service, or kept in-memory. In some embodiments, notifications and monitoring alerts can be submitted directly by gateway node 804, or leveraging a third-party service, to communicate changes in the generated auto-documentation or a status of the parsing process. In some embodiments, if parsing fails or the API transaction is not understood by the auto-documentation plugin, an error notification can also be sent. The AI-generated documentation will both generate documentation for APIs and microservices, and also for each individual route (or endpoint) for each one of the APIs.

In another embodiment, the auto-documentation is generated based on post-processing a request (e.g., sent by one or more clients) and post-processing a response (e.g., received from the API). At step 1, the client 802 makes a request to gateway node 804. At step 2, the gateway node 804 executes gateway functionalities but does not parse the request at this point. At step 3, the gateway node 804 proxies/load-balances the request to API 806, which returns a response. At step 4, the gateway node 804 parses the request and the response, and generates auto-documentation associated with the request and the response.

In some embodiments, pre-processing a request and post-processing a response is preferred over post-processing a request and post-processing a response. Such a scenario can arise when a user wishes to document a request, even if the resulting response returns an error or fails. Typically, pre-processing a request and post-processing a response is used to partially document an endpoint. In some embodiments, the reverse is preferred. Such a scenario doesn't allow for partial documentation and is used to document the entire transaction of the request and the end response.

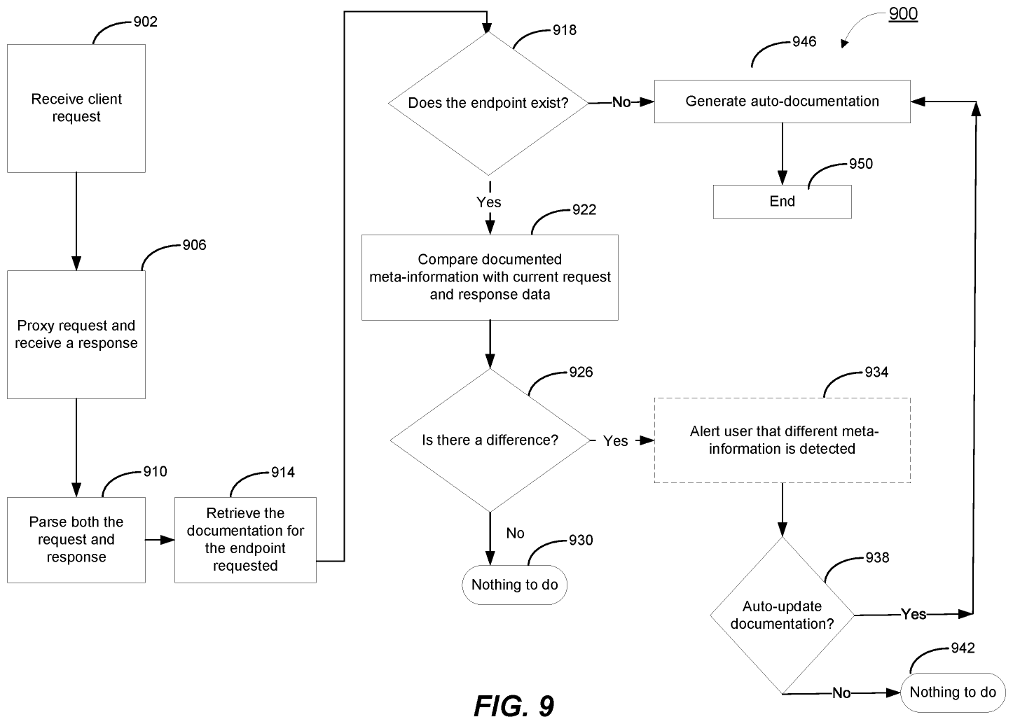

FIG. 9 illustrates a flow diagram 900 showing steps involved in generating auto-documentation at a gateway node, according to an embodiment of the disclosed technology. The flow diagram in FIG. 9 corresponds to the use-case when the auto-documentation is generated based on post-processing a request and post-processing a response. At step 902, a gateway node receives a client request. At step 906, the gateway node proxies the request and receives a response from the API. The response is sent back to the client. At step 910, the gateway node parses both the request and the response. At step 914, the gateway node retrieves (from local storage and remote storage of file system) the documentation for the endpoint requested. Retrieving the documentation for the endpoint is possible when the plugin has already auto-documented the same endpoint before.

Upon retrieving the prior documentation, the gateway node can compare the prior documentation with the current request to identify differences. At step 918, the gateway node determines whether the endpoint exists. If the gateway node determines that the endpoint exists, then the getaway node compares (at step 922) prior documented auto-documentation (in the retrieved documentation) with the current request and response data (e.g., headers, parameters, body, and other aspects of the request and response data). If the gateway node determines that there is no difference in the prior documented auto-documentation (in the retrieved documentation) and the current request and response data, then the gateway node enters (at step 930) a “nothing to do” state in which the gateway node doesn't take any further action and continues monitoring requests/responses to/from the API. If the gateway node determines (at step 926) that there is a difference in the prior documented auto-documentation (in the retrieved documentation) and the current request and response data, then the gateway node alerts/notifies (optionally, at step 934) a user that different auto-documentation is detected. The gateway node can notify the user via an internal alert module, sending an email to the user, or using a third-party notification service such as Pagerduty.

At step 938, the gateway node determines whether the auto-documentation is to be updated. If the gateway node determines that the auto-documentation does not need to be updated, then the gateway node enters (at step 942) a “nothing to do” state in which the gateway node doesn't take any further action, and continues monitoring requests/responses to/from the API. If the gateway node determines that the auto-documentation needs to be updated, then the gateway node generates (step 946) auto-documentation for the current API transaction and stores the request and response meta-information (e.g., headers, parameters, body, etc.) in a data store or local cache. In some embodiments, if the gateway node determines at step 918 that the endpoint does not exist, then the getaway node generates auto-documentation at step 946 which includes information about the endpoint (which is newly-created). If the documentation for a specific endpoint is missing, the reason could be because the endpoint is unique and has not been requested before.

An example of a request (e.g., sent by one or more clients) is provided below:
POST/do/something HTTP/1.1
Host: server
Accept: application/json
Content-Length: 25
Content-Type: application/x-www-form-urlencoded
param1=value&param2=value

An example of a response (e.g., received from the API) is provided below:
HTTP/1.1 200 OK
Connection: keep-alive
Date: Wed, 7 Jun. 2017 18:14:12 GMT
Content-Type: application/json
Content-Length: 33
{“created”:true, “param1”:“value”}

In other embodiments, the auto-documentation functionality can be integrated with an application server or a web server, and not necessarily a gateway node. In such embodiments, the application server (or the web server) can host the API application and be an entry point for an endpoint provided by the API.

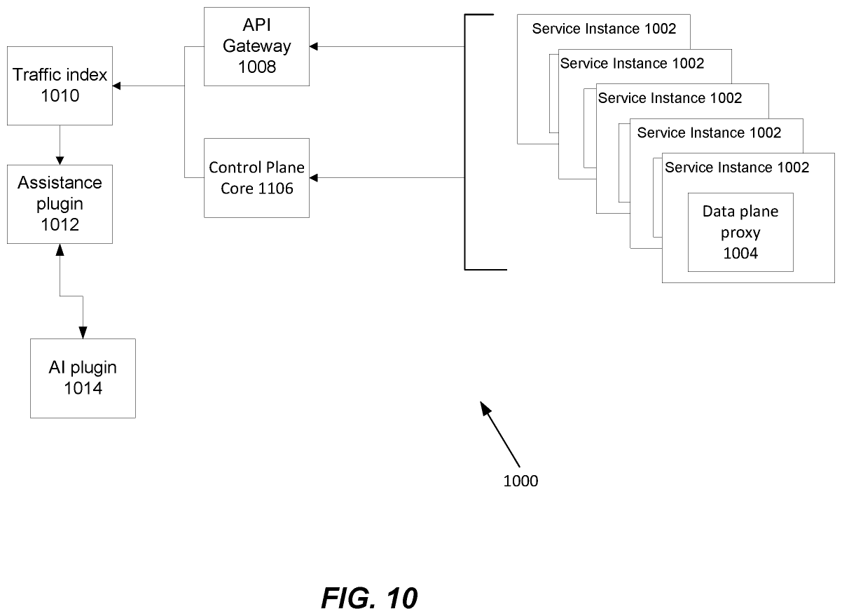

FIG. 10 is a block diagram that illustrates connecting an index set of traffic to an AI plugin. The microservices application 1000 includes a service mesh having a plurality of APIs/services 1002. In some embodiments, the services 1002 include data plane proxies 1004. The traffic through the service mesh is observed by a control plane 1006 and/or an API gateway 1008. The control plane 1006 provides policy and configuration for all of the running data planes in the mesh. The control plane 1006 typically does not touch any packets/requests in the system but collects the packets in the system. The control plane 1006 turns all the data planes into a distributed system. The API gateway 1008 performs a core set of functionalities including rate limiting, caching, authentication, logging, transformations, and security across the various machines (not pictured) the microservices application 1000 executes on.

The service mesh traffic that passes through the control plane 1006 and API gateway 1008 is sorted into a traffic index 1010. Embodiments of the traffic index 1010 include a plugin, a distributed plugin, an API, and function of the control plane 1006. The traffic index 1010 is configured to be searchable and machine readable. Embodiments of the data therein sort by API, API version, API service group, API function, parameters, whether the traffic is a request or response, and/or the variables included therein.

Within this specification, a number of API developer assistance features are described. These features are embodied as APIs or plugins themselves. For purposes of illustration these features are generally referenced in FIG. 10 as assistance plugin 1012. Assistance plugins 1012 consume the traffic index 1010, and in many cases communicate with an AI plugin 1014.

Communication with an AI plugin 1014 is typically restricted by limitations of query prompt size. Generative Als frequently employ character limits in queries. However, preconfigured queries are enabled to refer to an external source that does not have a character limit and generate output thereon. Thus, the assistance plugin 1012 frames requests to the AI plugin 1014 based on comparatively few characters that frame queries as based on ana analysis of the traffic index 1010. For example, an assistance plugin 1012 requests, given this OpenAPI specification, should a developer modify a given parameter based on traffic index 1014.

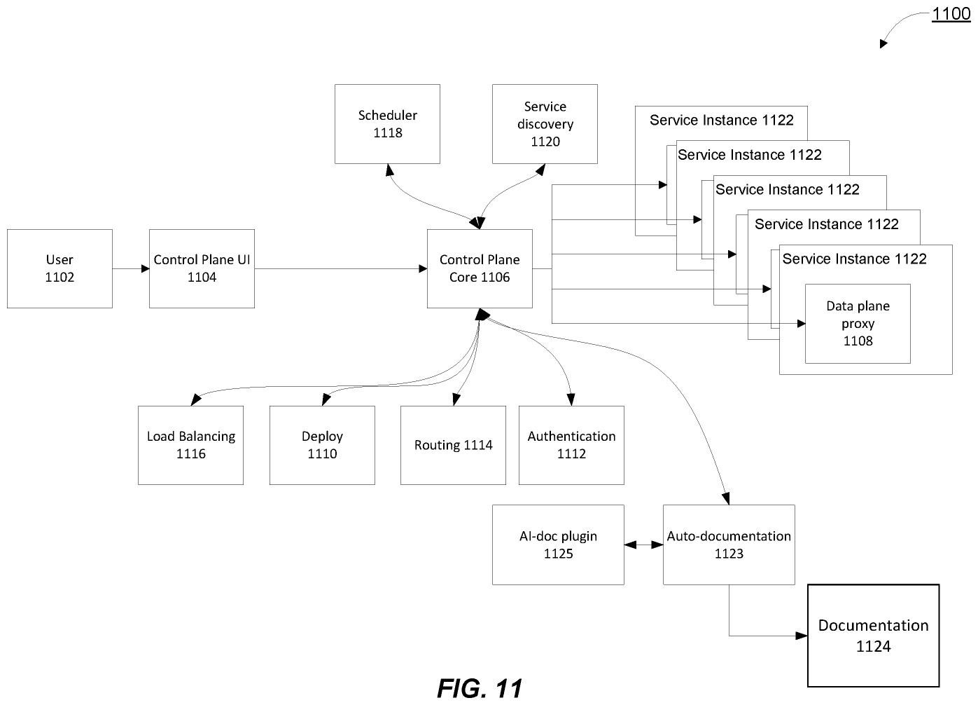

FIG. 11 is a block diagram of a control plane system 1100 for a service mesh in a microservices architecture. A service mesh data plane is controlled by a control plane. In a microservices architecture, each microservice typically exposes a set of what are typically fine-grained endpoints, as opposed to a monolithic application where there is just one set of (typically replicated, load-balanced) endpoints. An endpoint can be considered to be a URL pattern used to communicate with an API.

Service mesh data plane: Touches every packet/request in the system. Responsible for service discovery, health checking, routing, load balancing, authentication/authorization, and observability.

Service mesh control plane: Provides policy and configuration for all of the running data planes in the mesh. Does not touch any packets/requests in the system but collects the packets in the system. The control plane turns all the data planes into a distributed system.

A service mesh such as Linkerd, NGINX, HAProxy, Envoy co-locate service instances with a data plane proxy network proxy. Network traffic (HTTP, REST, gRPC, Redis, etc.) from an individual service instance flows via its local data plane proxy to the appropriate destination. Thus, the service instance is not aware of the network at large and only knows about its local proxy. In effect, the distributed system network has been abstracted away from the service programmer. In a service mesh, the data plane proxy performs a number of tasks. Example tasks disclosed herein include service discovery, update discovery, health checking, routing, load balancing, authentication and authorization, and observability.

Service discovery identifies each of the upstream/backend microservice instances within used by the relevant application. Health checking refers to detection of whether upstream service instances returned by service discovery are ready to accept network traffic. The detection may include both active (e.g., out-of-band pings to an endpoint) and passive (e.g., using 3 consecutive 5xx as an indication of an unhealthy state) health checking. The service mesh is further configured to route requests from local service instances to desired upstream service clusters.

Load balancing: Once an upstream service cluster has been selected during routing, a service mesh is configured load balance. Load balancing includes determining which upstream service instance should the request be sent; with what timeout; with what circuit breaking settings; and if the request fails should it be retried?

The service mesh further authenticates and authorizes incoming requests cryptographically using mTLS or some other mechanism. Data plane proxies enable observability features including detailed statistics, logging, and distributed tracing data should be generated so that operators can understand distributed traffic flow and debug problems as they occur.

In effect, the data plane proxy is the data plane. Said another way, the data plane is responsible for conditionally translating, forwarding, and observing every network packet that flows to and from a service instance.

The network abstraction that the data plane proxy provides does not inherently include instructions or built in methods to control the associated service instances in any of the ways described above. The control features are the enabled by a control plane. The control plane takes a set of isolated stateless data plane proxies and turns them into a distributed system.

A service mesh and control plane system 1100 includes a user 1102 whom interfaces with a control plane UI 1104. The UI 1104 might be a web portal, a CLI, or some other interface. Through the UI 1104, the user 1102 has access to the control plane core 1106. The control plane core 1106 serves as a central point that other control plane services operate through in connection with the data plane proxies 1108. Ultimately, the goal of a control plane is to set policy that will eventually be enacted by the data plane. More advanced control planes will abstract more of the system from the operator and require less handholding.

control plane services may include global system configuration settings such as deploy control 1110 (blue/green and/or traffic shifting), authentication and authorization settings 1112, route table specification 1114 (e.g., when service A requests a command, what happens), load balancer settings 1116 (e.g., timeouts, retries, circuit breakers, etc.), a workload scheduler 1118, and a service discovery system 1120. The scheduler 1118 is responsible for bootstrapping a service along with its data plane proxy 1118.

Services 1122 are run on an infrastructure via some type of scheduling system (e.g., Kubernetes or Nomad). Typical control planes operate in control of control plane services 1110-1120 that in turn control the data plane proxies 1108. Thus, in typical examples, the control plane services 1110-1120 are intermediaries to the services 1122 and associated data plane proxies 1108. An auto-documentation unit 1123 is responsible for parsing copied packets originating from the data plane proxies 1108 and associated with each service instance 1122. Data plane proxies 1108 catch requests and responses that are delivered in between services 1122 in addition to those that responses and requests that originate from outside of the microservices architecture (e.g., from external clients).

The auto-documentation unit 1123 updates documentation 1124 relevant to the associated service instances 1122 as identified by the auto-documentation unit 1123. In some embodiments, the auto-documentation communicates with an AI plugin 1125 that generates the documentation file 1124 based on an API source. Documentation 1124 may be present in source code for the services 1122 or in a separate document.

As depicted in FIG. 11, the control plane core 1106 is the intermediary between the control plane services 1110-1120 and the data plane proxies 1108. Acting as the intermediary, the control plane core 1106 removes dependencies that exist in other control plane systems and enables the control plane core 1106 to be platform agnostic. The control plane services 1110-1120 act as managed stores. With managed storages in a cloud deployment, scaling and maintaining the control plane core 1106 involves fewer updates. The control plane core 1106 can be split to multiple modules during implementation.

The control plane core 1106 passively monitors each service instance 1122 via the data plane proxies 1108 via live traffic. However, the control plane core 1106 may take active checks to determine the status or health of the overall application.

The control plane core 1106 supports multiple control plane services 1110-1120 at the same time by defining which one is more important through priorities. Employing a control plane core 1106 as disclosed aids control plane service 1110-1120 migration. Where a user wishes to change the control plane service provider (ex: changing service discovery between Zookeper based discovery to switch to Consul based discovery), a control plane core 1106 that receives the output of the control plane services 1110-1120 from various providers can configure each regardless of provider. Conversely, a control plane that merely directs control plane services 1110-1120 includes no such configuration store.

Another feature provided by the control plane core 1106 is Static service addition. For example, a user may run Consul, but you want to add another service/instance (ex: for debugging). The user may not want to add the additional service on the Consul cluster. Using a control plane core 1106, the user may plug the file-based source with custom definition multi-datacenter support. The user may expose the state hold in control plane core 1106 as HTTP endpoint, plug the control plane core 1106 from other datacenters as a source with lower priority. This will provide fallback for instances in the other datacenters when instances from local datacenter are unavailable.

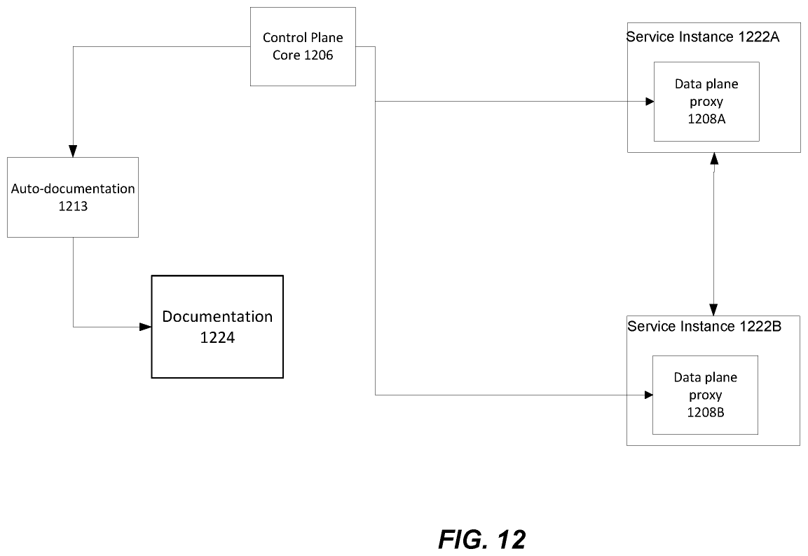

FIG. 12 is a block diagram illustrating communication between APIs resulting in updated documentation. In a microservices application architecture a plurality of APIs 1122A, B communicate with one another to produce desired results of a larger application. A control plane 1206 is communicatively coupled to the plurality of APIs 1122A, B via data plane proxies 1108A, B.

The control plane 1206 is configured to receive an incoming proxied request of a first API 1122A, via a respective data plane proxy 1108A, directed to a second API 1122B. The control plane 1206 receives the proxied response from the second API 1122B, via a respective second data plane proxy 1108B. In practice, there are many more APIs 1222 and respective proxies 1208 than the two pictured in the figure. Because of the microservices architecture, where each API is a “service,” the client/server relationship may exist in between many of the APIs that are intercommunicating within the microservices application.

Once received by the control plane 1206, auto-documentation unit 1213 of the control plane 1206 parses the proxied requests/responses and extracts current data similarly as described by other auto-documentation embodiments. The auto-documentation plugin is configured to generate auto-documentation in response to a transaction that includes the request and the response. The auto-documentation may be newly generated or updates to existing documentation. A data store including stores the newly created or updated documentation 1224.

In some embodiments, a set of APIs 1222 may operate together as a service group. A service group may have an additional documentation repository that refers to the functions/operations of methods within the service group at a higher level than a granular description of each API. Because the control plane 1206 has visibility on all requests and responses in the microservices architecture, the Auto-documentation module 1213 may identify similar or matching objects across the requests/responses of multiple APIs. Similar objects are those that are semantically similar, those that reference matching object or class titles (though other portions of the object name may differ, e.g., “user” and “validatedUser” are similar as they both refer to the user). In some embodiments, similar objects may also call for the same data type (e.g., string, int, float, Boolean, custom object classes, etc.) while in the same service group.

Thus, documentation 1224 that results may include a description of an execution path and multiple stages of input before reaching some designated output.

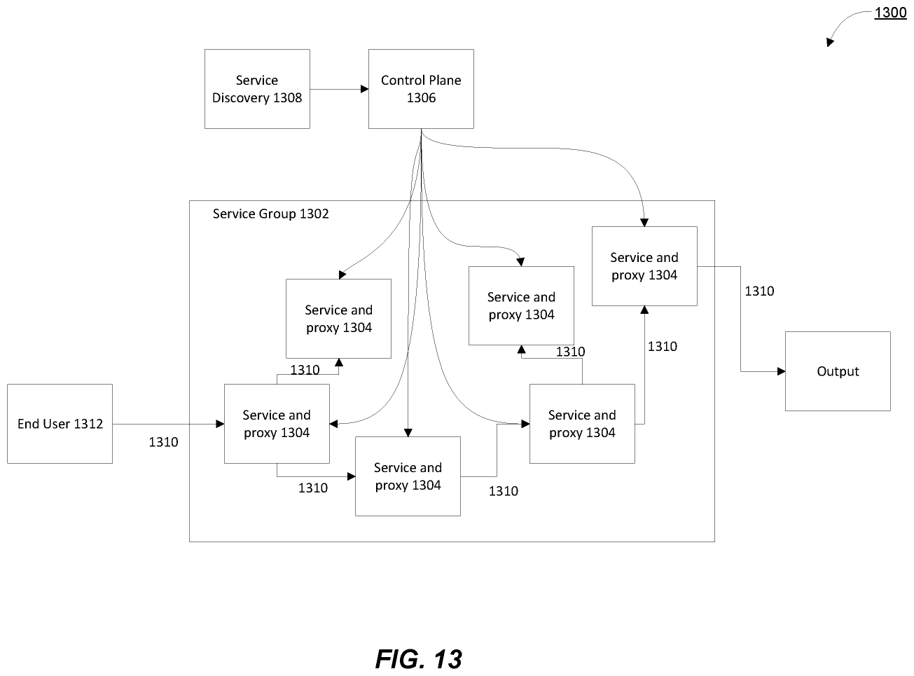

FIG. 13 is a block diagram illustrating service groups 1302 and features associated with identification thereof. A service group 1302 is a group of services 1304 that together perform an identifiable application purpose or business flow. For example, a set of microservices are responsible for an airline's ticketing portion of their website. Other examples may include “customer experience,” “sign up,” “login,” “payment processing”, etc. Using a control plane 1306 with an associated service discovery 1308 feature, packets are be monitored as they filter through the overall application (ex: whole website).

Given a starting point of a given service group 1302, the control plane 1306 may run a trace on packets having a known ID and follow where those packets (with the known ID) go in the microservice architecture as tracked by data plane proxies. In that way, the system can then automatically populate a service group 1302 using the trace. The trace is enabled via the shared execution path of the data plane proxies. Along each step 1310 between services 1304, the control plane 1304 measures latency and discover services. The trace may operate on live traffic corresponding to end users 1312, or alternatively using test traffic.

As output, the control plane generates a dependency graph of the given service group 1302 business flow and reports via a GUI. Using the dependency graph, a backend operator is provided insight into bottlenecks in the service group 1302. For example, in a given service group 1302, a set of services 1304 may run on multiple servers that are operated by different companies (e.g., AWS, Azure, Google Cloud, etc.). The latency between these servers may slow down the service group 1302 as a whole. Greater observability into the service group 1302 via a dependency graph enables backend operators to improve the capabilities and throughput of the service group 1302.

Auto-Testing of APIs

Based on the OpenAPI specifications, collections, real time traffic or any combination of thereof, an AI system is enabled to imply an expected API behavior and automatically create API tests (unit tests and integration tests) to accelerate developer productivity (creating tests is a huge time sink) and API reliability (developers traditionally create poor API tests).

An example API test generation program is Postman as developed by Postman, Inc. Postman executes tests automatically, but does require generation of API tests by developers often by using snippets. Writing test suites is time consuming.

The AI created tests are then executed directly on API gateways, API control planes, or API service hubs, or via API and command line interfaces (CLI) integrations so they can be automated with continuous integration/continuous deployment (Cl/CD) and developer pipelines. Testing is critical for microservices, and the more microservices/APIs a given applications has, the historically harder it has been for developers to keep up with proper testing practices.

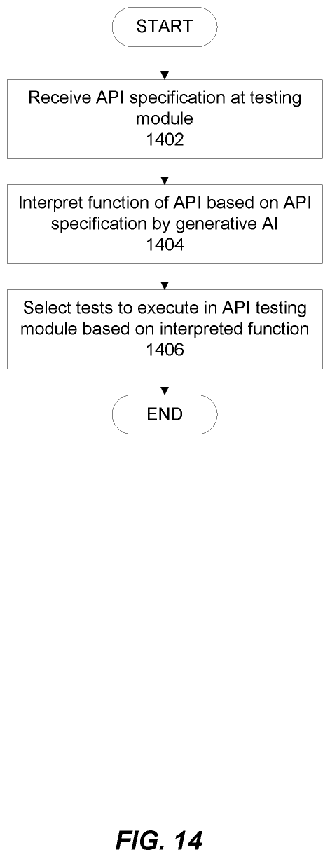

FIG. 14 is a flowchart illustrating automatic generating of API tests. In step 1402, an API specification is received by a test generation module. The test generation module is present in API gateways, API control planes, or API service hubs, CLI integrations, or Cl/CD pipelines. In each of these locations, receipt of the API specification may be periodic or otherwise automated. Triggers that cause delivery to the test generation module are similar to those that cause auto documentation features to trigger.

In step 1404, the API specification is passed to a generative AI API with a predetermined query. The predetermined query prompts the generative AI to interpret the function of the API based on the specification thereof. And then, subsequently prompts again using the generative AI interpreted result to propose a set of tests of an available testing suite. Each of these prompts are predetermined. In some embodiments, the second prompt instead requests the generative AI to limit the interpreted function into one of a prebuilt list of functional categories that have preassigned tests thereto (e.g., heuristically assigned).

In step 1406, the generative model selected tests are automatically passed to the API testing module and the module executes the tests on the subject API.

API Duplication Detection

In large microservices applications correspondingly large teams often are assigned to maintenance. These teams do not always have perfect communication therebetween. Thus, a generative AI is leveraged to determine if the Service Hub has copies of similar APIs that can be used instead of creating a new one. This is critical to avoid duplication of APIs/microservices which lowers the overall organization productivity and increases complexity.

In response to a developer or other administrator taking action to begin generating a new API or importing code, the generative AI is queried to determine whether the new subject API is a duplicate of another API based on the API catalog, and/or the live traffic of APIs via the API gateway or service mesh for APIs that may not even be in the catalog yet.

To perform analysis on the live traffic, the gateway generates an index of the live traffic to determine what an API does even if it has not been documented in the catalog, and based on that imply that an API already exists even if it's not explicitly in the catalog).

Where a match is identified, the user interface generates a link from the active or new subject API to the identified duplicate. The link directs to a Service Hub entry of the duplicate and enables the developer to consume the linked API in the manner the new subject API was intended for. Thus during initial phases of embarking on writing a “new” API, the user is simply directed by the user interface to a matching API that preexists the “new” API and the direction is to a platform that enables immediate use of the identified API.

### Exemplary Computer System

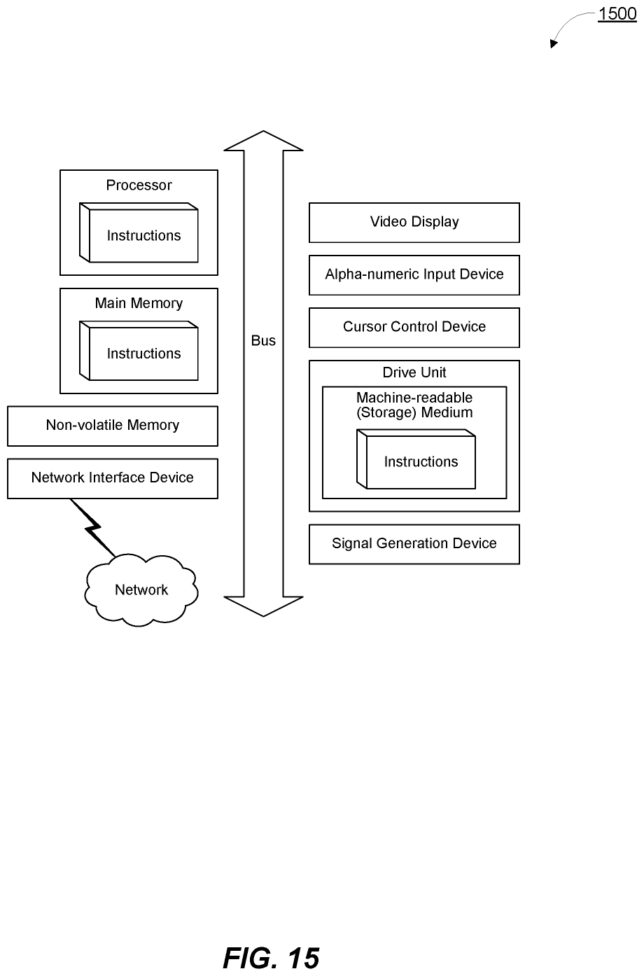

FIG. 15 shows a diagrammatic representation of a machine in the example form of a computer system 1500, within which a set of instructions for causing the machine to perform any one or more of the methodologies discussed herein may be executed.

In alternative embodiments, the machine operates as a standalone device or may be connected (networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone or smart phone, a tablet computer, a personal computer, a web appliance, a point-of-sale device, a network router, switch or bridge, or any machine capable of executing a set of instructions (sequential or otherwise) that specify actions to be taken by that machine.

While the machine-readable (storage) medium is shown in an exemplary embodiment to be a single medium, the term “machine-readable (storage) medium” should be taken to include a single medium or multiple media (a centralized or distributed database, and/or associated caches and servers) that store the one or more sets of instructions. The term “machine-readable medium” or “machine readable storage medium” shall also be taken to include any medium that is capable of storing, encoding or carrying a set of instructions for execution by the machine and that cause the machine to perform any one or more of the methodologies of the present invention.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine or computer-readable media include, but are not limited to, recordable type media such as volatile and non-volatile memory devices, floppy and other removable disks, hard disk drives, optical disks (e.g., Compact Disk Read-Only Memory (CD ROMS), Digital Versatile Discs, (DVDs), etc.), among others, and transmission type media such as digital and analog communication links.

AI System

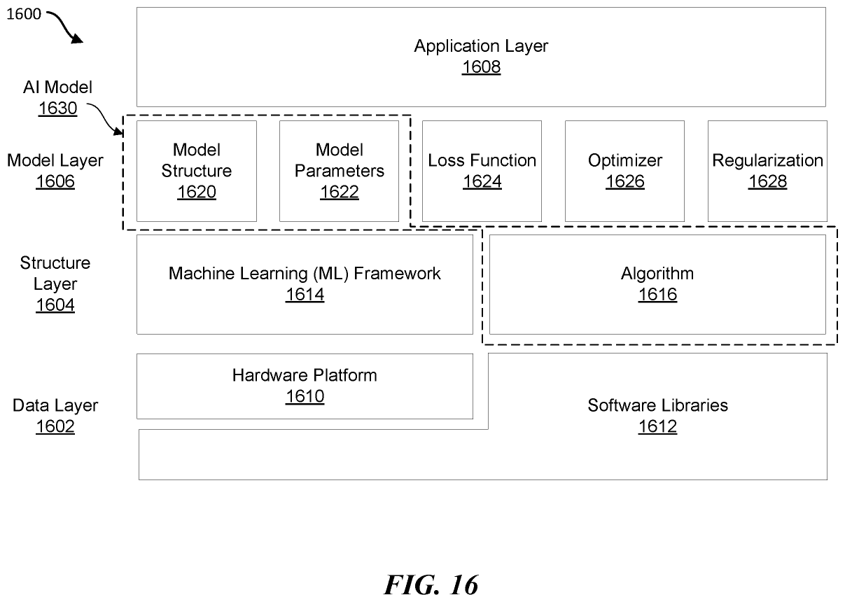

FIG. 16 is a high-level block diagram illustrating an example AI system, in accordance with one or more embodiments. The AI system 1600 is implemented using components of the example computer system 1500 illustrated and described in more detail with reference to FIG. 15. Likewise, embodiments of the AI system 1600 include different and/or additional components or be connected in different ways.

In some embodiments, as shown in FIG. 16, the AI system 1600 includes a set of layers, which conceptually organize elements within an example network topology for the AI system's architecture to implement a particular AI model 1630. Generally, an AI model 1630 is a computer-executable program implemented by the AI system 1600 that analyses data to make predictions. Information passes through each layer of the AI system 1600 to generate outputs for the AI model 1630. The layers include a data layer 1602, a structure layer 1604, a model layer 1606, and an application layer 1608. The algorithm 1616 of the structure layer 1604 and the model structure 1620 and model parameters 1622 of the model layer 1606 together form the example AI model 1630. The optimizer 1626, loss function engine 1624, and regularization engine 1628 work to refine and optimize the AI model 1630, and the data layer 1602 provides resources and support for the application of the AI model 1630 by the application layer 1608.

The data layer 1602 acts as the foundation of the AI system 1600 by preparing data for the AI model 1630. As shown, in some embodiments, the data layer 1602 includes two sub-layers: a hardware platform 1610 and one or more software libraries 1612. The hardware platform 1610 is designed to perform operations for the AI model 1630 and includes computing resources for storage, memory, logic, and networking, such as the resources described in relation to FIG. 3. The hardware platform 1610 processes amounts of data using one or more servers. The servers can perform backend operations such as matrix calculations, parallel calculations, machine learning (ML) training, and the like. Examples of servers used by the hardware platform 1610 include central processing units (CPUs) and graphics processing units (GPUs). CPUs are electronic circuitry designed to execute instructions for computer programs, such as arithmetic, logic, controlling, and input/output (I/O) operations, and can be implemented on integrated circuit (IC) microprocessors. GPUs are electric circuits that were originally designed for graphics manipulation and output but may be used for AI applications due to their vast computing and memory resources. GPUs use a parallel structure that generally makes their processing more efficient than that of CPUs. In some instances, the hardware platform 1610 includes Infrastructure as a Service (laaS) resources, which are computing resources, (e.g., servers, memory, etc.) offered by a cloud services provider. In some embodiments, the hardware platform 1610 includes computer memory for storing data about the AI model 1630, application of the AI model 1630, and training data for the AI model 1630. In some embodiments, the computer memory is a form of random-access memory (RAM), such as dynamic RAM, static RAM, and non-volatile RAM.

In some embodiments, the software libraries 1612 are thought of as suites of data and programming code, including executables, used to control the computing resources of the hardware platform 1610. In some embodiments, the programming code includes low-level primitives (e.g., fundamental language elements) that form the foundation of one or more low-level programming languages, such that servers of the hardware platform 1610 can use the low-level primitives to carry out specific operations. The low-level programming languages do not require much, if any, abstraction from a computing resource's instruction set architecture, allowing them to run quickly with a small memory footprint. Examples of software libraries 1612 that can be included in the AI system 1600 include Intel Math Kernel Library, Nvidia cuDNN, Eigen, and Open BLAS.

In some embodiments, the structure layer 1604 includes an ML framework 1614 and an algorithm 1616. The ML framework 1614 can be thought of as an interface, library, or tool that allows users to build and deploy the AI model 1680. In some embodiments, the ML framework 1614 includes an open-source library, an application programming interface (API), a gradient-boosting library, an ensemble method, and/or a deep learning toolkit that works with the layers of the AI system facilitate development of the AI model 1630. For example, the ML framework 1614 distributes processes for the application or training of the AI model 1630 across multiple resources in the hardware platform 1610. In some embodiments, the ML framework 1614 also includes a set of pre-built components that have the functionality to implement and train the AI model 1630 and allow users to use pre-built functions and classes to construct and train the AI model 1630. Thus, the ML framework 1614 can be used to facilitate data engineering, development, hyperparameter tuning, testing, and training for the AI model 1630. Examples of ML frameworks 1614 that can be used in the AI system 1600 include TensorFlow, PyTorch, Scikit-Learn, Keras, Caffe, LightGBM, Random Forest, and Amazon Web Services.

In some embodiments, the algorithm 1616 is an organized set of computer-executable operations used to generate output data from a set of input data and can be described using pseudocode. In some embodiments, the algorithm 1616 includes complex code that allows the computing resources to learn from new input data and create new/modified outputs based on what was learned. In some implementations, the algorithm 1616 builds the AI model 1630 through being trained while running computing resources of the hardware platform 1610. The training allows the algorithm 1616 to make predictions or decisions without being explicitly programmed to do so. Once trained, the algorithm 1616 runs at the computing resources as part of the AI model 1630 to make predictions or decisions, improve computing resource performance, or perform tasks. The algorithm 1616 is trained using supervised learning, unsupervised learning, semi-supervised learning, and/or reinforcement learning. The application layer 1608 describes how the AI system 1600 is used to solve problems or perform tasks.

As an example, to train an AI model 1630 that is intended to model human language (also referred to as a language model), the data layer 1602 is a collection of text documents, referred to as a text corpus (or simply referred to as a corpus). The corpus represents a language domain (e.g., a single language), a subject domain (e.g., scientific papers), and/or encompasses another domain or domains, be they larger or smaller than a single language or subject domain. For example, a relatively large, multilingual, and non-subject-specific corpus is created by extracting text from online web pages and/or publicly available social media posts. In some embodiments, data layer 1602 is annotated with ground truth labels (e.g., each data entry in the training dataset is paired with a label), or unlabeled.

Training an AI model 1630 generally involves inputting into an AI model 1630 (e.g., an untrained ML model) data layer 1602 to be processed by the AI model 1630, processing the data layer 1602 using the AI model 1630, collecting the output generated by the AI model 1630 (e.g., based on the inputted training data), and comparing the output to a desired set of target values. If the data layer 1602 is labeled, the desired target values, in some embodiments, are, e.g., the ground truth labels of the data layer 1602. If the data layer 1602 is unlabeled, the desired target value is, in some embodiments, a reconstructed (or otherwise processed) version of the corresponding AI model 1630 input (e.g., in the case of an autoencoder), or is a measure of some target observable effect on the environment (e.g., in the case of a reinforcement learning agent). The parameters of the AI model 1630 are updated based on a difference between the generated output value and the desired target value. For example, if the value outputted by the AI model 1630 is excessively high, the parameters are adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the AI model 1630 typically is to minimize a loss function or maximize a reward function.

In some embodiments, the data layer 1602 is a subset of a larger data set. For example, a data set is split into three mutually exclusive subsets: a training set, a validation (or cross-validation) set, and a testing set. The three subsets of data, in some embodiments, are used sequentially during AI model 1630 training. For example, the training set is first used to train one or more ML models, each AI model 1630, e.g., having a particular architecture, having a particular training procedure, being describable by a set of model hyperparameters, and/or otherwise being varied from the other of the one or more ML models. The validation (or cross-validation) set, in some embodiments, is then used as input data into the trained ML models to, e.g., measure the performance of the trained ML models and/or compare performance between them. In some embodiments, where hyperparameters are used, a new set of hyperparameters is determined based on the measured performance of one or more of the trained ML models, and the first step of training (i.e., with the training set) begins again on a different ML model described by the new set of determined hyperparameters. These steps are repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) begins in some embodiments. The output generated from the testing set, in some embodiments, is compared with the corresponding desired target values to give a final assessment of the trained ML model's accuracy. Other segmentations of the larger data set and/or schemes for using the segments for training one or more ML models are possible.

Backpropagation is an algorithm for training an AI model 1630. Backpropagation is used to adjust (also referred to as update) the value of the parameters in the AI model 1630, with the goal of optimizing the objective function. For example, a defined loss function is calculated by forward propagation of an input to obtain an output of the AI model 1630 and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. In some embodiments, other techniques for learning the parameters of the AI model 1630 are used. The process of updating (or learning) the parameters over many iterations is referred to as training. In some embodiments, training is carried out iteratively until a convergence condition is met (e.g., a predefined maximum number of iterations has been performed, or the value outputted by the AI model 1630 is sufficiently converged with the desired target value), after which the AI model 1630 is considered to be sufficiently trained. The values of the learned parameters are then fixed and the AI model 1630 is then deployed to generate output in real-world applications (also referred to as “inference”).

In some examples, a trained ML model is fine-tuned, meaning that the values of the learned parameters are adjusted slightly in order for the ML model to better model a specific task. Fine-tuning of an AI model 1630 typically involves further training the ML model on a number of data samples (which may be smaller in number/cardinality than those used to train the model initially) that closely target the specific task. For example, an AI model 1630 for generating natural language that has been trained generically on publicly available text corpora is, e.g., fine-tuned by further training using specific training samples. In some embodiments, the specific training samples are used to generate language in a certain style or a certain format. For example, the AI model 1630 is trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

In some embodiments, the language model uses a neural network (typically a DNN) to perform NLP tasks. A language model is trained to model how words relate to each other in a textual sequence, based on probabilities. In some embodiments, the language model contains hundreds of thousands of learned parameters, or in the case of a large language model (LLM) contains millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

Although a general transformer architecture for a language model and the model's theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that is considered to be an encoder-only language model. A decoder-only language model accepts embeddings as input and uses auto-regression to generate an output text sequence. Transformer-XL and GPT-type models are language models that are considered to be decoder-only language models.

Because GPT-type language models tend to have a large number of parameters, these language models are considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that GPT-3 can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model is hosted by a computer system that includes a plurality of cooperating (e.g., cooperating via a network) computer systems that are in, for example, a distributed arrangement. Notably, a remote language model employs a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real-time or near real-time) can require the use of a plurality of processors/cooperating computing devices as discussed above.

In some embodiments, inputs to an LLM are referred to as a prompt, which is a natural language input that includes instructions to the LLM to generate a desired output. In some embodiments, a computer system generates a prompt that is provided as input to the LLM via the LLM's API. As described above, the prompt is processed or pre-processed into a token sequence prior to being provided as input to the LLM via the LLM's API. A prompt includes one or more examples of the desired output, which provides the LLM with additional information to enable the LLM to generate output according to the desired output. Additionally or alternatively, the examples included in a prompt provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples is referred to as a zero-shot prompt.

In some embodiments, the Ilama2 is used as a large language model, which is a large language model based on an encoder-decoder architecture, and can simultaneously perform text generation and text understanding. The Ilama2 selects or trains proper pre-training corpus, pre-training targets and pre-training parameters according to different tasks and fields, and adjusts a large language model on the basis so as to improve the performance of the large language model under a specific scene.

In some embodiments, the Falcon40B is used as a large language model, which is a causal decoder-only model. During training, the model predicts the subsequent tokens with a causal language modeling task. The model applies rotational positional embeddings in the model's transformer model and encodes the absolution positional information of the tokens into a rotation matrix.

In some embodiments, the Claude is used as a large language model, which is an autoregressive model trained on a large text corpus unsupervised.

Consequently, alternative language and synonyms can be used for any one or more of the terms discussed herein, and no special significance is to be placed upon whether or not a term is elaborated or discussed herein. Synonyms for certain terms are provided. A recital of one or more synonyms does not exclude the use of other synonyms. The use of examples anywhere in this specification including examples of any term discussed herein is illustrative only and is not intended to further limit the scope and meaning of the disclosure or of any exemplified term. Likewise, the disclosure is not limited to various embodiments given in this specification.

It is to be understood that the embodiments and variations shown and described herein are merely illustrative of the principles of this invention and that various modifications can be implemented by those skilled in the art.

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described but can be practiced with modification and alteration within the spirit and scope of the appended claims. Accordingly, the specification and drawings are to be regarded in an illustrative sense rather than a restrictive sense

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

All patents, applications and references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, ¶6, other aspects may likewise be embodied as a means-plus-function claim, or in other forms, such as being embodied in a computer-readable medium. (Any claims intended to be treated under 35 U.S.C. § 112, 1j6 will begin with the words “means for.”) Accordingly, the applicant reserves the right to add additional claims after filing the application to pursue such additional claim forms for other aspects of the disclosure.

1. A method for managing Application Programming Interfaces (APIs) in a microservices architecture, the method comprising:
communicatively coupling a plurality of APIs organized into a microservices application architecture;
coordinating, by an API management platform, data associated with the plurality of APIs of the microservices application;
providing, to an artificial intelligence plugin, parameter names or parameter data types of a first API of the plurality of APIs, wherein output of the artificial intelligence plugin indicates an expected operation of the first API based on the parameter names or parameter data types; and
automatically updating, a documentation file associated with the first API based on the output of the artificial intelligence plugin.

2. The method of claim 1, wherein said automatically updating by the artificial intelligence plugin is based on training of the artificial intelligence plugin connected to semantic interpretation.

3. The method of claim 1, wherein the parameter data types or the parameter names are drawn from a proxied request/response transaction with the first API, and the output of the artificial intelligence plugin is further based on the proxied request/response transaction.

4. The method of claim 2, wherein the output by the artificial intelligence plugin is based on training of the artificial intelligence plugin connected to a historical model of a request/response schema.

5. The method of claim 1, further comprising:
providing a memory architecturally separate from the plurality of APIs, the memory including a program code library configured to execute functionalities common to execution of the plurality of APIs on a node in communication with the memory.

6. The method of claim 1, wherein the documentation file is in the form of a Swagger file, an OpenAPI Specification, a JSON file, a RAML file, or an API Blueprint file.

7. The method of claim 1, further comprising:
generating a notification displayed to a user indicative that the parameter names or parameter data types of the first API of the plurality of APIs are inconsistent with an observed traffic index of the microservices architecture.

8. A method for managing Application Programming Interfaces (APIs) in a microservices architecture, the method comprising:
communicatively coupling a plurality of APIs organized into a microservices application architecture, the plurality of APIs and, by extension, the microservices application architecture maintained by an API management platform;
receiving, by the API management platform, user input of a predetermined type associated with a first API of the plurality of APIs of the microservices application, the user input configured to cause the API management platform to modify the first API;
providing data descriptive of the first API in parallel with modification of the first API to an artificial intelligence plugin as at least a portion of a query prompt that causes the artificial intelligence plugin to generate or update a documentation file associated with the first API based on the data descriptive of the first API; and
receiving, by the API management platform, the documentation file.

9. The method of claim 8, wherein the artificial intelligence plugin is based on training connected to semantic interpretation.

10. The method of claim 8, wherein the documentation file is in the form of a Swagger file, an OpenAPI Specification, a JSON file, a RAML file, or an API Blueprint file.

11. The method of claim 8, wherein the user input of the predetermined type is any of:
completion of a developer session that logs out a developer user;
executing a runtime test;
causing an active file to be saved;
a lack of changes to the first API over a predetermined time period; or
a first API changelog indication that a threshold change has been made to source code of the first API.

12. The method of claim 8, wherein the data descriptive of the first API is any of:
existing documentation files;
an OpenAPI specification;
a collection of test results of the first API; or
data describing live traffic through an API gateway, ingress controller or service mesh.

13. The method of claim 8, wherein the data descriptive of the first API is includes a query call to the artificial intelligence plugin indicating how the documentation file is to be generated based on the data descriptive of the first API.

14. The method of claim 8, further comprising:
generating a notification displayed to a user indicative that the parameter names or parameter data types of the first API of the plurality of APIs are inconsistent with an observed traffic index of the microservices architecture.

15. A system for managing Application Programming Interfaces (APIs) in a microservices architecture, the system comprising:
an API management platform including a memory that stores a plurality of APIs organized into a microservices application architecture, the plurality of APIs and, by extension, the API management platform configured to maintain the microservices application architecture;
a user interface coupled to the API management platform configured to receive user input of a predetermined type associated with a first API of the plurality of APIs of the microservices application, the user input configured to cause the API management platform to modify the first API; and
a network interface communicatively coupled to the API management platform, the network interface configured to provide data descriptive of the first API in parallel with modification of the first API to an artificial intelligence plugin as at least a portion of a query prompt that causes the artificial intelligence plugin to generate or update a documentation file associated with the first API based on the data descriptive of the first API, the network interface further configured to receive the documentation file from the artificial intelligence plugin.

16. The system of claim 15, wherein the artificial intelligence plugin is based on training connected to semantic interpretation.

17. The system of claim 15, wherein the documentation file is in the form of a Swagger file, an OpenAPI Specification, a JSON file, a RAML file, or an API Blueprint file.

18. The system of claim 15, wherein the user input of the predetermined type is any of:
completion of a developer session that logs out a developer user;
executing a runtime test;
causing an active file to be saved;
a lack of changes to the first API over a predetermined time period; or
a first API changelog indication that a threshold change has been made to source code of the first API.

19. The system of claim 15, wherein the data descriptive of the first API is any of:
existing documentation files;
an OpenAPI specification;
a collection of test results of the first API; or
data describing live traffic through an API gateway, ingress controller or service mesh.

20. The system of claim 15, wherein the data descriptive of the first API is includes a query call to the artificial intelligence plugin indicating how the documentation file is to be generated based on the data descriptive of the first API.
